(19) United States
(12) Patent Application Publication
(10) Pub. No.: US 2020/0322237 A1
(43) Pub. Date: Oct. 8, 2020

(54) TRAFFIC DETECTION METHOD AND TRAFFIC DETECTION DEVICE

(71) Applicant: HUAWEI TECHNOLOGIES CO., LTD., Shenzhen (CN)

(72) Inventors: Tao LUO, Xi'an (CN); Jianwei GUO, Xi'an (CN); Liuqing PENG, Xi'an (CN)

(21) Appl. No.: 16/910,361

(22) Filed: Jun. 24, 2020

Related U.S. Application Data
(63) Continuation of application No. PCT/CN2018/121917, filed on Dec. 19, 2018.

(30) Foreign Application Priority Data
Mar. 6, 2018 (CN) 201810183112.3

(51) Int. Cl. H04L 12/26

(52) U.S. Cl. CPC H04L 43/04; H04L 43/067; H04L 43/0894

(57) ABSTRACT

A traffic detection method includes obtaining a plurality of packets collected by a traffic collection device in a first time period, where the plurality of packets include packets in a first data stream and at least one other data stream collected in the first time period; determining a target feature set based on the plurality of packets, where the target feature set includes a multi-stream feature corresponding to the plurality of packets, and the multi-stream feature includes a statistical parameter about sizes of the plurality of packets; and determining, based on the target feature set and a correspondence between the target feature set and a service type, a service type corresponding to the first data stream collected in the first time period. According to the traffic detection method, more features can be obtained, and accuracy of traffic detection can be improved by using more features.

### CROSS-REFERENCE TO RELATED APPLICATIONS

This disclosure is a continuation of International Application No. PCT/CN2018/121917, filed on Dec. 19, 2018, which claims priority to Chinese Patent Application No. 201810183112.3, filed on Mar. 6, 2018. The disclosures of the aforementioned applications are hereby incorporated by reference in their entireties.

### TECHNICAL FIELD

Example embodiments of this application relate to the communications field, and in particular, to a traffic detection method and a traffic detection device.

### BACKGROUND

Traffic identification is always an important research field in Internet data analysis fields, and it is also widely applied. A traffic identification technology is a basis for performing refined traffic management and experience quality evaluation and assurance, and can provide user-level and service-level experience quality monitoring and optimization. The traffic identification technology is a basis for performing precision operations by a carrier, and can provide services such as an over the top (OTT) user portrait and precision marketing. In addition, traffic identification is of great significance in other scenarios such as network security.

Different service types have different requirements on levels of network quality indicators such as bandwidths and network delays, but evaluation and optimization of the indicators need to be refined to granularities of service types. Therefore, to implement the foregoing services, service types in traffic need to be identified. The service types may include video viewing, web browsing, Speedtest speed testing, YouTube online video viewing, file transfer, web television, network radio, instant messaging, and the like. For example, a traffic throughput of a data stream changes as the time elapses, and is related to different types of services that a user of the data stream performs at different times. There are obvious differences among throughputs of different services. Therefore, if indicators are discussed irrespective of service types, it is impossible to accurately evaluate whether a current network quality indicator (using the throughput as an example herein) is acceptable, and whether experience quality of a service performed by the user is normal. However, network traffic identification can support analysis of indicators and experience quality from perspectives of service types.

In the prior art, the traffic identification technology based on a fixed time window is approximately as follows: using a fixed time window (such as 15 seconds) to collect packets of a data stream, and then identifying a service type of the data stream based on information carried in the packets, for example, information about a field used to represent a service type, or a quantity of packets in the data stream in the time window, or a ratio of uplink traffic to downlink traffic.

Accuracy of the traffic detection method in the prior art is not high.

### SUMMARY

In view of the above, example embodiments of this application provide a traffic detection method and a traffic detection device. To determine a service type of a data stream, a multi-stream feature is extracted from packets in the data stream and at least one data stream that belongs to a same user as that of the data stream. Because impact of other data streams of the same user on the data stream can be considered in the multi-stream feature, the data stream can be described more accurately, and accuracy of traffic detection on the data stream can be improved.

A first aspect of this application provides a traffic detection method, where the traffic detection method is applied to a traffic detection device. The method includes: obtaining a plurality of packets collected by a traffic collection device in a first time period, where the plurality of packets include packets in a first data stream and at least one other data stream associated with the first data stream, and the first data stream and the at least one other data stream are data streams of a same user; determining a target feature set based on the plurality of packets, where the target feature set includes a multi-stream feature corresponding to the plurality of packets, and the multi-stream feature includes a statistical parameter about sizes of the plurality of packets; and determining, based on the target feature set and a correspondence between the target feature set and a service type, a service type corresponding to the first data stream in the first time period. A packet size may be a total length of a packet, or may be a length of data included in a packet. For example, a length of data is a length of application layer data included in a packet, and this is not limited in embodiments of the present disclosure.

Based on this implementation, to determine a service type of a data stream, a multi-stream feature is extracted from packets in the data stream and at least one data stream that belongs to a same user as the data stream. Because impact of other data streams of the same user on the data stream can be considered in the multi-stream feature, the data stream can be described more accurately, and accuracy of traffic detection is improved.

In a possible implementation, the multi-stream feature further includes at least one of a statistical parameter about reception time intervals corresponding to the plurality of packets or a statistical parameter about transmission rates of the plurality of packets. The reception time interval corresponding to the plurality of packets is a reception time interval between any two consecutively received packets in the plurality of packets. In another possible implementation, the reception time interval may be calculated at intervals of a same quantity of packets. For example, the reception time interval is calculated at intervals of one packet, or calculated at intervals of a plurality of packets. Based on this implementation, a feature type of the multi-stream feature is added, and the accuracy of traffic detection can be further improved.

In another possible implementation, the first time period is related to a statistical parameter of a plurality of packets collected by the traffic collection device in a second time period.

In another possible implementation, the method further includes: obtaining a plurality of packets collected by the traffic collection device in a second time period, where the plurality of packets collected in the second time period include packets in the first data stream and the at least one other data stream; and if a time difference between a time of receiving a last packet of the user by the traffic collection device in the second time period and an end time of the second time period is less than a preset threshold, determining the first time period, where the first time period is longer than the second time period, and the second time period is in the first time period. Based on this implementation, a time window used for obtaining packets may be expanded to obtain more packets, to obtain a message sequence that is more complete. In comparison with a feature extracted from a message sequence segment, a feature extracted from a complete message sequence is more accurate, and therefore the accuracy of traffic detection can be improved.

In another possible implementation, the obtaining a plurality of packets collected by a traffic collection device in a first time period specifically includes: obtaining a plurality of packets collected by the traffic collection device in a second time period, where the plurality of packets collected in the second time period include packets in the first data stream and the at least one other data stream; and if a time difference between a time of receiving a last packet in the first data stream by the traffic collection device in the second time period and an end time of the second time period is less than a preset threshold, obtaining a plurality of packets collected by the traffic collection device in a third time period, where a sum of the second time period and the third time period is the first time period. Alternatively, if a time difference between a time of receiving a last packet in the first data stream by the traffic collection device in the second time period and an end time of the second time period is not less than a preset threshold, the second time period is the same as the first time period. Based on this implementation, a time window used for obtaining packets may be expanded to obtain more packets, to obtain a message sequence that is more complete. In comparison with a feature extracted from a message sequence segment, a feature extracted from a complete message sequence is more accurate, and therefore the accuracy of traffic detection can be improved.

In another possible implementation, the method further includes: obtaining a plurality of packets collected by the traffic collection device in a second time period, where the plurality of packets collected in the second time period include packets in the first data stream and the at least one other data stream; and if a total amount of data received by the traffic collection device in the second time period is greater than a preset data amount, determining the first time period, where the first time period is longer than the second time period, and the second time period is within the first time period. Alternatively, if a total amount of data received by the traffic collection device in the second time period is not greater than a preset data amount, the second time period is the same as the first time period. In this way, another method for expanding a time window is provided, and a message sequence that is more complete can be obtained, to improve the accuracy of traffic detection.

In another possible implementation, the determining, based on the target feature set and a correspondence between the target feature set and a service type, a service type corresponding to the first data stream in the first time period includes: finding a first feature set in a feature library based on the target feature set, where the first feature set is a feature set having a highest similarity with the target feature set among feature sets in the feature library; and determining, based on a correspondence between the first feature set and a service type, the service type corresponding to the first data stream in the first time period, where the service type corresponding to the first data stream in the first time period is the same as the service type corresponding to the first feature set. Because the first feature set has the highest similarity with the target feature set, a probability that a service type corresponding to the plurality of packets is the same as the service type of the first feature set is highest. Therefore, a traffic detection function can be implemented.

In another possible implementation, the target feature set further includes a single-stream feature corresponding to the packets in the first data stream that are collected in the first time period, and the single-stream feature includes a statistical parameter about sizes of the collected packets in the first data stream. Further, the single-stream feature further includes at least one of a statistical parameter about reception time intervals of the collected packets in the first data stream or a statistical parameter about transmission rates thereof, where the reception time interval is a reception time interval between any two consecutively received packets in the collected packets in the first data stream. In this way, when searching the feature library for a similar feature set, the traffic detection device not only needs to compare multi-stream features, but also needs to compare single-stream features. More features can indicate a data stream more completely and accurately, and can further improve the accuracy of traffic detection.

In another possible implementation, the target feature set further includes a feature of a transaction in the first data stream collected in the first time period, the transaction includes a plurality of packets, the plurality of packets included in the transaction are a request and at least one response corresponding to the request, and the feature of the transaction includes a statistical parameter about sizes of the plurality of packets included in the transaction. Further, the feature of the transaction further includes a statistical parameter about reception time intervals corresponding to the plurality of packets included in the transaction and a statistical parameter about transmission rates of the plurality of packets included in the transaction. In this way, when searching the feature library for a similar feature set, the traffic detection device not only needs to compare multi-stream features, but also needs to compare transaction features. More features can indicate a data stream more completely and accurately, and can further improve the accuracy of traffic detection.

In the foregoing possible implementations, the statistical parameter includes at least one of an average value, a maximum value, a minimum value, a standard deviation, a quantile, kurtosis, skewness, or a spectrum parameter. For the foregoing parameters, types and quantities of selected statistical parameters may be the same or different. In addition to the foregoing statistical parameters, other types of parameters such as a variance, a covariance, and a range may be used. Types of statistical parameters that may be used in the technical solution of this application are not limited in embodiments of the present disclosure.

In another possible implementation, the method further includes: training a plurality of new samples and a plurality of historical samples by using a machine learning algorithm, to update a correspondence between a feature set and a service type in the feature library, where the plurality of new samples include a sample corresponding to the first data stream in the first time period, and the sample corresponding to the first data stream includes a multi-stream feature and the service type of the first data stream. The historical samples are samples that are obtained before the new samples are obtained. Because the generated new samples and the historical samples are trained together, the correspondence between a feature set and a service type can be updated and corrected, and the updated correspondence between a feature set and a service type is closer to the current correspondence between a data stream and a service type and can also be more diversified. By using the updated correspondence between a feature set and a service type during identification, on one hand, more data streams can be identified, and on the other hand, the accuracy of traffic detection can also be improved.

In another possible implementation, the plurality of new samples includes a first new sample, the first new sample corresponds to a feature set in the feature library, the first new sample includes a group of high-confidence features, a similarity between the group of high-confidence features and the feature set in the feature library satisfies a preset condition, and a service type included in the first new sample is the same as a service type corresponding to the feature set in the feature library corresponding to the first new sample. In this way, a high-confidence feature set and a service type corresponding to the high-confidence feature set may be used as a new sample, thereby avoiding using a sample including a low-confidence feature set as a training sample.

In another possible implementation, at least one other new sample is included in the plurality of new samples, and the method further includes: obtaining a server identity that corresponds to a data stream collected by the traffic collection device in a time period, where the server identity includes an Internet Protocol (IP) address of a server and a name of the server; determining a service type of the data stream based on a correspondence between the server identity and a service type; and storing a second new sample corresponding to the data stream, where the second new sample includes the service type and a multi-stream feature of the data stream in the time period. In an embodiment, some servers provide only one type of service. Therefore, the server identity may be used to determine types of services provided by the server for some data streams in a time period. In other words, a new sample including a service type can be obtained in a plurality of manners. A variety of manners for obtaining new samples also helps obtain more new samples.

A second aspect provides a traffic detection method. The method includes: obtaining a plurality of packets collected by a traffic collection device in a first time period, where the plurality of packets include packets of at least one transaction in a first data stream collected in the first time period; determining a target feature set based on the plurality of packets, where the target feature set includes a feature of the transaction in the first data stream collected in the first time period, a plurality of packets included in each transaction comprise a request and at least one response corresponding to the request, and the feature of the transaction includes a statistical parameter about sizes of the plurality of packets included in the transaction and determining, based on the target feature set and a correspondence between the target feature set and a service type, a service type corresponding to the first data stream in the first time period. Based on this implementation, the service type corresponding to the first data stream may be determined based on the feature of the transaction in the first data stream. Therefore, a new method for identifying a data stream is provided and has good feasibility.

In a possible implementation, the feature of the transaction further includes at least one of a statistical parameter about reception time intervals corresponding to the plurality of packets included in the transaction or a statistical parameter about transmission rates of the plurality of packets included in the transaction, and the reception time interval corresponding to the plurality of packets is a reception time interval between any two consecutively received packets in the plurality of packets.

In another possible implementation, the method further includes: determining a feature of a first transaction based on a plurality of packets included in the first transaction, where the first transaction is any one of the at least one transaction; and determining, based on the feature of the first transaction and a correspondence between the feature of the first transaction and a service type, a service type corresponding to the first transaction.

In another possible implementation, the statistical parameter includes at least one of an average value, a maximum value, a minimum value, a standard deviation, a quantile, kurtosis, skewness, or a spectrum parameter.

In another possible implementation, the method further includes: training a plurality of new samples and a plurality of historical samples by using a machine learning algorithm, to update a correspondence between a feature set and a service type in a feature library, where the plurality of new samples include a sample corresponding to a transaction in the first data stream in the first time period, and the sample corresponding to the transaction in the first data stream includes a feature and a service type of the transaction in the first data stream. Because the generated new samples and the historical samples are trained together, the correspondence between a feature set and a service type can be updated and corrected, and the updated correspondence between a feature set and a service type is closer to the current correspondence between a data stream and a service type and can also be more diversified. By using the updated correspondence between a feature set and a service type during identification, on one hand, more data streams can be identified, and on the other hand, the accuracy of traffic detection can also be improved.

In another possible implementation, at least one first new sample is included in the plurality of new samples, the first new sample corresponds to a feature set in the feature library, the first new sample includes a group of high-confidence features, a similarity between the group of high-confidence features and the feature set in the feature library satisfies a preset condition, and a service type included in the first new sample is the same as a service type corresponding to the feature set corresponding to the first new sample.

In another possible implementation, at least one other new sample is included in the plurality of new samples, and the method further includes: obtaining a server identity that corresponds to the transaction in the first data stream collected by the traffic collection device in the first time period, where the server identity includes an Internet Protocol (IP) address of a server and a name of the server; determining the service type of the transaction in the first data stream based on a correspondence between the server identity and a service type; and storing a second new sample corresponding to the transaction in the first data stream in the first time period, where the second new sample includes the service type of the transaction in the first data stream and the feature of the transaction in the first data stream, and the feature of the transaction includes at least one statistical parameter.

A third aspect provides a sample training method. The method includes: identifying service types of a plurality of data streams in a time period to obtain a plurality of new samples; and training an updated sample set by using a machine learning algorithm, to obtain an updated correspondence set, where the updated correspondence set includes a plurality of mapping relationships, and the mapping relationships are mapping relationships between feature sets and service types, where the updated sample set includes a plurality of new samples and a plurality of historical samples, each sample in the updated sample set includes one service type and a plurality of features, the plurality of features include at least one of a multi-stream feature, a single-stream feature, or a transaction feature, and each of the multi-stream feature, the single-stream feature, and the transaction feature includes at least one statistical parameter. Because the generated new samples and the historical samples are trained together, a correspondence between a feature set and a service type can be updated and corrected, and the stored correspondence between the feature set and the service type is closer to a current correspondence between a data stream and a service type and can also be more diversified. By using the updated correspondence between a feature set and a service type during identification, on one hand, more data streams can be identified, and on the other hand, accuracy of traffic detection can also be improved.

In a possible implementation, at least one first new sample is included in the plurality of new samples, the first new sample corresponds to a feature set in a feature library, the first new sample includes a group of high-confidence features, a similarity between the group of high-confidence features and the feature set in the feature library satisfies a preset condition, and a service type included in the first new sample is the same as a service type corresponding to the feature set in the feature library corresponding to the first new sample.

In another possible implementation, at least one other new sample is included in the plurality of new samples, and the method further includes: obtaining a server identity that corresponds to a data stream collected by a traffic collection device in a time period, where the server identity includes an Internet Protocol (IP) address of a server and a name of the server, determining a service type of the data stream based on a correspondence between the server identity and a service type; and storing a second new sample corresponding to the data stream in the time period, where the second new sample includes the service type of the data stream and a multi-stream feature of the data stream.

A fourth aspect provides a traffic detection device. The traffic detection device includes an obtaining module, a feature determining module, and a service type determining module, where the obtaining module is configured to obtain a plurality of packets collected by a traffic collection device in a first time period, where the plurality of packets include packets in a first data stream and at least one other data stream associated with the first data stream, and the first data stream and the at least one other data stream are data streams of a same user, the feature determining module is configured to determine a target feature set based on the plurality of packets, where the target feature set includes a multi-stream feature corresponding to the plurality of packets, and the multi-stream feature includes a statistical parameter about sizes of the plurality of packets; and the service type determining module is configured to determine, based on the target feature set and a correspondence between the target feature set and a service type, a service type corresponding to the first data stream in the first time period. The traffic detection device is a device corresponding to the method in the first aspect. For specific implementations, technical effects, and descriptions, refer to the corresponding descriptions about the first aspect.

A fifth aspect provides a traffic detection device. The traffic detection device includes an obtaining module, a feature determining module, and a service type determining module, where the obtaining module is configured to obtain a plurality of packets collected by a traffic collection device in a first time period, where the plurality of packets include packets of at least one transaction in a first data stream collected in the first time period; the feature determining module is configured to determine a target feature set based on the plurality of packets, where the target feature set includes a feature of the transaction in the first data stream collected in the first time period, a plurality of packets included in the transaction are a request and at least one response corresponding to the request, and the feature of the transaction includes a statistical parameter about sizes of the plurality of packets included in the transaction; and the service type determining module is configured to determine, based on the target feature set and a correspondence between the target feature set and a service type, a service type corresponding to the first data stream in the first time period. The traffic detection device is a device corresponding to the method in the second aspect. For specific implementations, technical effects, and descriptions, refer to the corresponding descriptions about the second aspect.

A sixth aspect provides a sample training device. The sample training device includes a sample marking module and a training module, where the sample marking module is configured to identify service types of a plurality of data streams collected in a time period to obtain a plurality of new samples; and the training module is configured to train an updated sample set by using a machine learning algorithm, to obtain an updated correspondence set, where the updated correspondence set includes a plurality of mapping relationships, and the mapping relationships are mapping relationships between feature sets and service types, where the updated sample set includes a plurality of new samples and a plurality of historical samples, each sample in the updated sample set includes one service type and a plurality of features, the plurality of features include at least one of a multi-stream feature, a single-stream feature, or a transaction feature, and each of the multi-stream feature, the single-stream feature, and the transaction feature includes at least one statistical parameter. The traffic training device is a device corresponding to the method in the third aspect. For specific implementations, technical effects, and descriptions, refer to the corresponding descriptions about the third aspect.

A seventh aspect provides a traffic detection device, including a communications interface, a processor, and a memory that are connected by using a bus, where the memory is configured to store a program and a packet; and the processor executes the program to implement the method according to the first aspect.

An eighth aspect provides a traffic detection device, including a communications interface, a processor, and a memory that are connected by using a bus, where the memory is configured to store a program and a packet; and the processor executes the program to implement the method according to the second aspect.

Another aspect of this application provides a computer-readable storage medium, where the computer-readable storage medium stores instructions, and when the instructions are run on a computer, the computer is enabled to perform the method according to each of the foregoing aspects.

Another aspect of this application provides a computer program product including instructions, where when the computer program product is run on a computer, the computer is enabled to perform the method according to each of the foregoing aspects.

### DESCRIPTION OF DRAWINGS

FIG. 1 is a schematic diagram of a system architecture according to an embodiment of this application;

FIG. 2 is a schematic diagram of functional modules of a traffic collection device according to an embodiment of this application;

FIG. 3 is a schematic diagram of a traffic detection method according to an embodiment of this application;

FIG. 4 is a flowchart of a traffic detection method according to an embodiment of this application;

FIG. 5a is a schematic diagram for obtaining packets in an expanded time window according to an embodiment of this application;

FIG. 5b is a schematic diagram for obtaining packets in a non-expanded time window according to an embodiment of this application;

FIG. 6a is another schematic diagram for obtaining packets in an expanded time window according to an embodiment of this application;

FIG. 6b is another schematic diagram for obtaining packets in a non-expanded time window according to an embodiment of this application;

FIG. 7a is a schematic diagram of a message sequence according to an embodiment of this application;

FIG. 7b is another schematic diagram of a message sequence according to an embodiment of this application;

FIG. 8a is another schematic diagram of a message sequence according to an embodiment of this application;

FIG. 8b is another schematic diagram of a message sequence according to an embodiment of this application;

FIG. 9 is another flowchart of a traffic detection method according to an embodiment of this application;

FIG. 10 is a flowchart of a sample training method according to an embodiment of this application;

FIG. 11 is a schematic diagram of a traffic detection device according to an embodiment of this application;

FIG. 12 is another schematic diagram of a traffic detection device according to an embodiment of this application;

FIG. 13 is another schematic diagram of a traffic detection device according to an embodiment of this application;

FIG. 14 is a schematic diagram of a sample training device according to an embodiment of this application;

FIG. 15 is another schematic diagram of a sample training device according to an embodiment of this application;

FIG. 16 is another schematic diagram of a traffic detection device according to an embodiment of this application; and

FIG. 17 is another schematic diagram of a sample training device according to an embodiment of this application.

### DESCRIPTION OF EXAMPLE EMBODIMENTS

First, some terms used in embodiments of this application are explained:

A plurality of pieces of packet information may be collected from a packet. The packet information may include but is not limited to: a packet size, a packet reception time interval, a packet transmission rate, a ratio of uplink traffic to downlink traffic of packets, a quantity of packets, and the like.

The packet size, that is, a size of a packet, may be a total length of a packet, or may be a length of data included in a packet. The packet size may be indicated by a quantity of bytes, but this is not limited in example embodiment of the present disclosure. For a packet, which part of the packet is specific data included in the packet depends on a protocol corresponding to the packet. For example, a length of data is a length of application layer data included in a packet, and this is not limited in embodiments of the present disclosure. Using an Internet Protocol (IP) packet as an example, a data encapsulation format of the IP packet is IP packet header+IP payload. The IP payload is a Transmission Control Protocol (TCP) packet. To be specific, IP payload=TCP packet header+TCP payload. The TCP payload is application layer data. In an implementation, a size of a packet in the embodiments of this application may be a size of a TCP payload.

It should be understood that, because the method and apparatus described in this application have a plurality of implementations, meanings of a term or a phrase may be different in different implementations. However, in one implementation (such as in one method procedure), technical meanings of a technical term such as the packet size should be consistent. Using the term packet size as an example, a total packet length is used as a packet size for each packet in an implementation, or a length of data included in a packet is used as a packet size for each packet in another implementation. For a phrase or a term having a plurality of meanings in this application, refer to descriptions in this paragraph. This issue is not described in detail again hereinafter.

The packet reception time interval is a reception time interval between any two consecutively received packets. In addition, the reception time interval may be calculated at intervals of a same quantity of packets. For example, the reception time interval is calculated at intervals of one packet, or calculated at intervals of a plurality of packets.

The packet transmission rate is an amount of data transmitted within a unit time, where the unit may be bits per second or bytes per second.

The ratio of uplink traffic to downlink traffic of packets is a ratio of an amount of data of uplink packets to an amount of data of downlink packets within a unit time. An uplink packet is a packet sent by a user terminal to a network. A downlink packet is a packet sent by a network to a user terminal.

Based on the packet information, statistical parameters may be obtained through calculation. The statistical parameters include but are not limited to an average value, a maximum value, a minimum value, a standard deviation, a quantile, kurtosis, skewness, a spectrum parameter, a variance, a covariance, and a range. For the foregoing statistical parameters, types and quantities of statistical parameters used to represent different features may be different.

The average value includes an arithmetic average value, a weighted average value, and the like. For N numeric values that need to be processed, the arithmetic average value is a ratio of a sum of the N numeric values to N. The weighted average value is a ratio of a sum of weighted numeric values to N after each numeric value is weighted.

For the N numeric values that need to be processed, the quantile indicates a value of an independent variable when the N numeric values are used as dependent variables of a cumulative distribution function. The quantile includes a 2-quantile, a 4-quantile, a 100-quantile, or the like. The 2-quantile is also referred to as a median.

For the N numeric values that need to be processed, kurtosis is used to indicate steepness of a distribution form of the N numeric values, and skewness is used to indicate a leaning direction and degree of distribution of the N numeric values.

A feature set includes one or more features, and each feature is a statistical parameter of packet information.

Confidence is the degree of trust of a processed feature set. Specifically, whether the processed feature set is a high-confidence feature set or a low-confidence feature set may be determined based on a similarity between the processed feature set and a feature set in a feature library. For example, when the similarity between the processed feature set and a feature set in the feature library is higher than a threshold, the processed feature set is determined as a high-confidence feature set; otherwise, the processed feature set is a low-confidence feature set.

The similarity is the degree of similarity between two feature sets that are compared. Specifically, feature values in two feature sets may be processed by using a similarity formula, and an obtained calculation result is a value of a similarity between the two feature sets. The similarity formula may be a Euclidean distance formula, a Manhattan distance formula, an angle cosine formula, or a Pearson correlation coefficient formula. If a value interval of the similarity is [0, 1], when a value of the similarity is 1, it indicates that the two feature sets that are compared are the same.

A short-time service is a service having transmission duration shorter than or equal to a preset duration, for example, an interactive messaging (such as instant messaging or an SMS) service, or a multimedia messaging service. A long-time service is a service having a transmission duration longer than a preset duration, for example, a file transfer service or a Voice over Internet Protocol (VoIP) service. A large-traffic service is a service having a data amount greater than a preset data amount within a preset time, for example, an online video service. A small-traffic service is a service having a data amount not greater than a preset data amount within a preset time, for example, interactive messaging or multimedia messaging. For the large-traffic service, a data transmission task requires a relatively long time. For the small-traffic service, a data transmission task requires a relatively short time.

A communications network may be used to transmit a data stream exchanged between terminals, between cloud servers, between a terminal and a cloud server, or the like, and the data stream is usually used to carry data of a service. For data of a type of service transmitted in a data stream in a time period, it may be considered that the data stream corresponds to the type of the service (referred to as a service type hereinafter in the present disclosure) in the time period. The traffic detection method provided in the present disclosure is applied to a traffic detection device. The traffic detection device may be located in a carrier network. A detected data stream may be a data stream exchanged between terminals, between cloud servers, between a terminal and a cloud server, or the like.

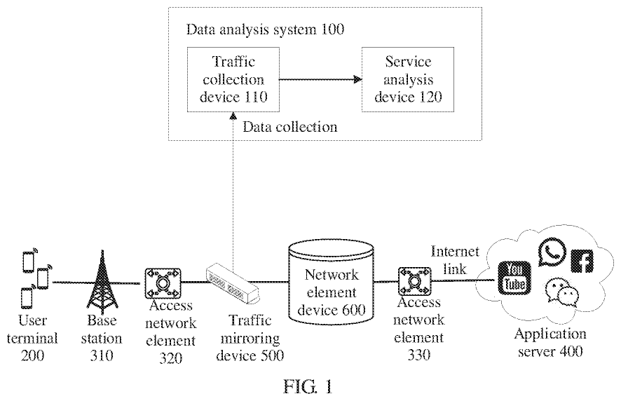

FIG. 1 is a schematic diagram of a system architecture of a system according to an embodiment of this application. As shown in FIG. 1, the system includes a data analysis system 100, a user terminal 200, a carrier network device, a traffic mirroring device 500, a network element device 600, access network elements 320, 330, and a server, where the server may be an application server 400 or the like.

The carrier network device may be an access network device (such as a base station 310 or a relay), a router, a switch, or the like.

The application server 400 is connected to the user terminal 200 by using the carrier network device, and is configured to trigger and execute a network application program. The network application program is, for example, an instant messaging application program (such as WeChat), a video application program (such as YouTube), or a social networking application program (such as Facebook).

The user terminal 200 is an electronic device having a computing capability, for example, a mobile phone, a personal computer, a tablet computer, an in-vehicle computer, a wearable electronic device, or a self-service terminal.

The data analysis system 100 includes a traffic collection device 110. In an embodiment, the data analysis system also includes a traffic detection device, and the traffic collection device 110 and the traffic detection device are different devices. The traffic collection device 110 obtains, from the carrier network device, a data stream transmitted between the user terminal 200 and the application server 400, and the traffic detection device identifies packets in the data stream collected by the traffic collection device 110. In another embodiment, a traffic detection device is implemented by software running on a traffic collection device, and software running on the traffic collection device implements a traffic data collection function and a traffic detection function. It may be understood that, the data analysis system may further include a service analysis device 120.

Service types of data streams include but are not limited to: web browsing, online video, online audio, file transfer, multimedia, Voice over Internet Protocol (VoIP), and interactive messaging. The VoIP service includes but is not limited to a VoIP audio service and a VoIP video service.

The service analysis device 120 performs service analysis based on a traffic identification result and a key quality indicator (KQI), and feeds back a service analysis result to a user and a carrier. The KQI is a service quality parameter that is close to user experience and that is provided for different services. For example, the data analysis system 100 monitors experience quality based on a KQI to analyze experience quality of a service of the user. Alternatively, the data analysis system 100 determines a network optimization solution based on a KQI, and the application server 400 performs network optimization after obtaining the network optimization solution from the data analysis system 100. Alternatively, the data analysis system 100 analyzes a network fault based on a KQI, and obtains a network fault solution, and the application server 400 performs fault diagnosis based on the network fault solution obtained from the data analysis system 100.

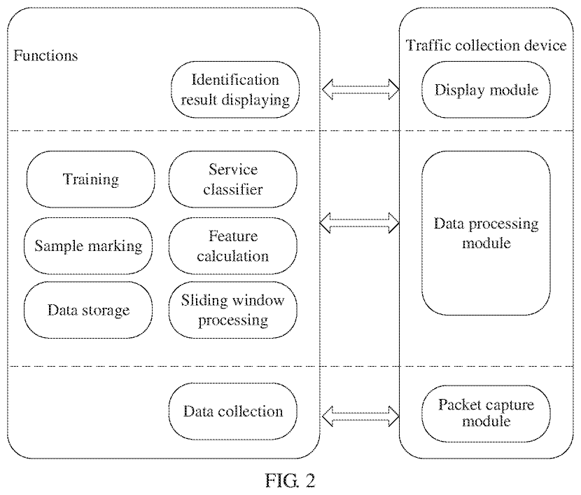

FIG. 2 is a schematic diagram of a traffic collection device according to an embodiment of the present disclosure. In this case, traffic detection is implemented in the traffic collection device. Referring to FIG. 2, the traffic collection device may include a packet capture module, a data processing module, and a display module.

The packet capture module is configured to capture a packet from a network, for example, capture a packet that passes through a gateway device.

The data processing module is configured to perform data processing on the packet captured by the packet capture module. Specifically, the data processing module may implement functions such as data storage, feature calculation, sample marking, training, and identification. It may be understood that, each function of the data processing module may be performed by an independent submodule. For example, a storage submodule performs a data storage function, a data processing submodule implements a feature calculation and identification function, a sample marking submodule implements a sample marking function, and a training submodule implements a training function.

The display module is configured to display an identification result after the data processing module completes processing.

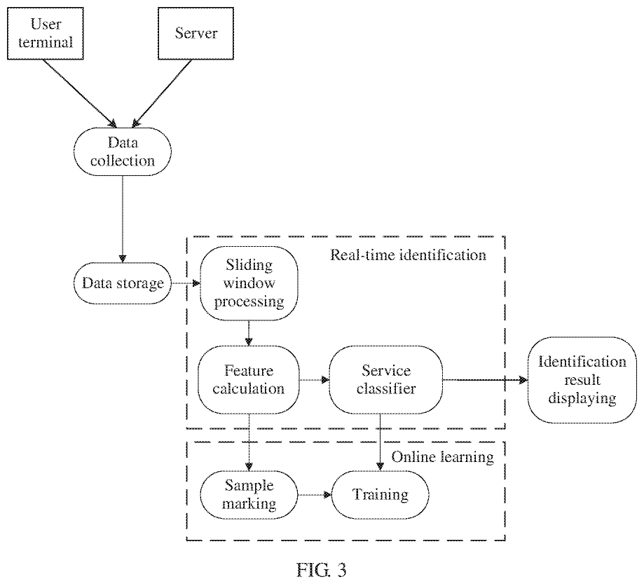

Referring to FIG. 3, a non-limiting, example traffic collection device collects data from a network device (such as a user terminal or a server) and stores the data. First, a collected packet is analyzed, and if a sliding window condition is satisfied, sliding window processing is performed. A sampling window is expanded after the sliding window processing, and a packet obtained from the expanded window is used as a to-be-processed packet. Then after feature calculation is performed on the to-be-processed packet to obtain at least one feature, a service type corresponding to the to-be-processed packet is determined based on a correspondence between the at least one feature and the service type, and then an identification result is displayed. In this way, a function of identifying a data stream in real time is implemented.

In addition, feature calculation is performed on the to-be-processed packet, and a calculation result is compared with a historical feature set. If a feature set similar to the calculation result exists, a service type corresponding to the similar feature set is used as the service type of the to-be-processed packet. In this way, a feature value obtained through calculation is used as a new sample, the service type corresponding to the similar feature set is used as a sample label to form a new training set, and a correspondence between a feature set and a service type is updated by using a machine learning algorithm. In this way, the correspondence between a feature set and a service type can be updated rapidly through online learning, so that traffic detection is accurately performed on new data.

It may be understood that, the packet capture module, the data processing module, and the display module may also be implemented by using mutually connected independent devices. The traffic collection device may further include a configuration management module, configured to set and manage a system parameter of the traffic collection device.

Data collected by the traffic collection device is variable-length message sequences of various service types. Therefore, before identification, a to-be-processed message sequence needs to be first segmented into several blocks. In the prior art, a fixed time window is used to collect traffic data (the traffic data is collected packets in the time window), and then a service type of a data stream is identified based on information carried in the packets, for example, information about a field used to represent a service type, or a quantity of packets in the data stream in the time window, or a ratio of uplink traffic to downlink traffic.

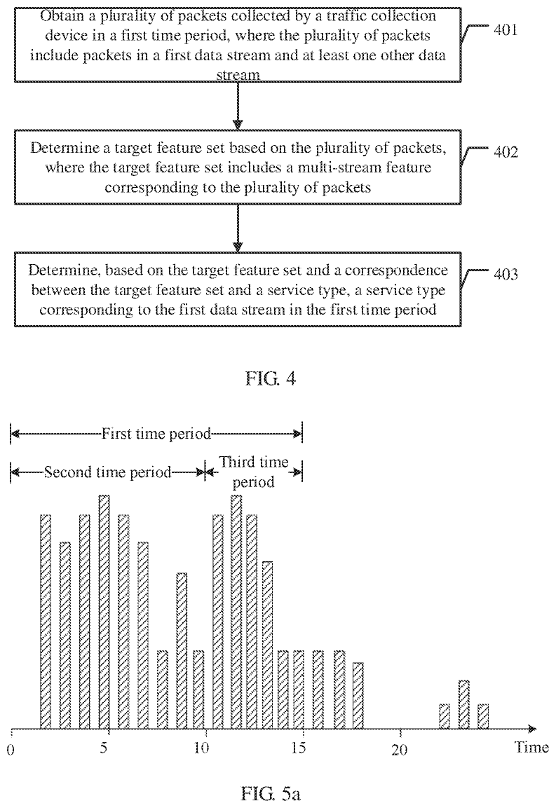

To improve accuracy of traffic identification, in this embodiment, a plurality of data streams of a same user may be selected, a multi-stream feature of packets is extracted after the packets in a time period are obtained from the data streams, and then a service type corresponding to the packets in the time period is determined based on a target feature set including the multi-stream feature. The following provides detailed descriptions. Referring to FIG. 4, a non-limiting, example traffic detection method includes the following steps.

Step 401: Obtain a plurality of packets collected by a traffic collection device in a first time period, where the plurality of packets include packets in a first data stream and at least one other data stream associated with the first data stream.

In this embodiment, the first data stream and the at least one other data stream are data streams of a same user. Duration of the first time period may be set to a fixed duration or a variable duration.

An Internet Protocol (IP) 5-tuple includes an IP address of a user terminal, a port number of the user terminal, an IP address of a server, a port number of the server, and a protocol type. A traffic detection device determines data streams of a user in to-be-detected data streams based on the IP address of the user terminal, and then samples the plurality of data streams of the user, for example, extracts a plurality of packets in a time period from the plurality of data streams. Likewise, the traffic detection device may determine data streams of a server in the to-be-detected data streams based on an IP address of the server, and then sample the plurality of data streams of the server.

It should be noted that, the traffic detection device may be integrated in the traffic collection device as a software module running in the traffic collection device, or may be deployed as independent hardware.

Step 402: Determine a target feature set based on the plurality of packets, where the target feature set includes a multi-stream feature corresponding to the plurality of packets.

The multi-stream feature is a feature extracted from the plurality of data streams of the same user, where the quantity may be one or more. The multi-stream feature includes at least one statistical parameter about sizes of the plurality of packets. Optionally, the multi-stream feature further includes but is not limited to at least one statistical parameter about reception time intervals of the plurality of packets or at least one statistical parameter about transmission rates of the plurality of packets. The multi-stream feature may further include a quantity of the plurality of packets obtained from the first data stream and the other data stream in the first time period. The statistical parameter may be an average value, a maximum value, a minimum value, a standard deviation a quantile, kurtosis, skewness, a spectrum parameter or the like. In addition to the statistical parameters used in the foregoing example other types of parameters such as a variance, a covariance, and a range may be used. Types of statistical parameters used in the technical solution of this application are not limited in embodiments of the present disclosure.

It may be understood that, the target feature set may include at least one of statistical parameter about sizes of the plurality of packets, a statistical parameter about reception time intervals corresponding to the plurality of packets, or a statistical parameter about transmission rates of the plurality of packets. Details may be shown in Table 1.

TABLE 1

| | |
|---|---|
| Statistical parameter | Average value of sizes of packets |
| about sizes of packets | Maximum value of sizes of packets |
| | Minimum value of sizes of packets |
| | Standard deviation of sizes of packets |
| | Quantile of sizes of packets |
| | Kurtosis of sizes of packets |
| | Skewness of sizes of packets |
| | Spectrum parameter about sizes of packets |
| Statistical parameter about | Average value of reception time intervals of packets |
| reception time intervals of | Maximum value of reception time intervals of packets |
| packets | Minimum value of reception time intervals of packets |
| | Standard deviation of reception time intervals of packets |
| | Quantile of reception time intervals of packets |
| | Kurtosis of reception time intervals of packets |
| | Skewness of reception time intervals of packets |
| | Spectrum parameter about reception time intervals of packets |
| Statistical parameter about | Average value of transmission rates of packets |
| transmission rates of packets | Maximum value of transmission rates of packets |
| | Minimum value of transmission rates of packets |
| | Standard deviation of transmission rates of packets |
| | Quantile of transmission rates of packets |
| | Kurtosis of transmission rates of packets |
| | Skewness of transmission rates of packets |
| | Spectrum parameter about transmission rates of packets |

The quantity of the plurality of packets collected from the first data stream and the at least one other data stream is marked with N, and the multi-stream feature corresponding to the N packets is determined, where N is a positive integer. The following briefly describes a method for calculating a multi-stream feature value corresponding to the sizes of the N packets.

(1) A formula for calculating an average value is:

$$\overline{x} = \frac{1}{N} {\sum }_{i = 1}^{N} {x}_{i} ,$$

where xᵢ is a size of an i^{th} packet, x̅ is an arithmetic average value of the sizes of the packets, and N is a total quantity of the sizes of the packets.

It may be understood that, the average value may also be a weighted average value or another average value.

(2) The sizes of all the N packets are calculated, and a largest value is selected from the sizes of the packets.

(3) The sizes of all the N packets are calculated, and a smallest value is selected from the sizes of the packets.

(4) A standard deviation of the sizes of the packets is used to indicate a discrete degree of the sizes of the packets.

A formula for calculating the standard deviation is:

$$σ = \sqrt{\frac{1}{N} {\sum }_{i = 1}^{N} {( {x}_{i} - \overline{x} )}^{2}} ,$$

where σ is a standard deviation of the sizes of the packets, N is the total quantity of the sizes of the packets, xᵢ is the size of the i^{th} packet, and x̅ is the arithmetic average value of the sizes of the packets.

(5) A quantile of the sizes of the packets indicates a value of an independent variable when the sizes of the packets are used as dependent variables of a cumulative distribution function. The quantile includes a 2-quantile, a 4-quantile, a 100-quantile, or the like. The 2-quantile is also referred to as a median. The following uses the 2-quantile as an example. A manner of calculating the 2-quantile is as follows: When the quantity of packets is an odd number, a middle one is selected as the 2-quantile after the sizes of all the packets are sorted; or when the quantity of packets is an even number, middle two are selected after the sizes of all the packets are sorted, and an average value of sizes of the two packets is used as the 2-quantile.

(6) Kurtosis of the sizes of the packets is used to indicate steepness of a distribution form of the sizes of the packets.

A formula for calculating kurtosis may be as follows:

First, a variance D is calculated:

$$D = \frac{1}{N} {\sum }_{i = 1}^{N} {( {x}_{i} - \overline{x} )}^{2} .$$

Then kurtosis E is calculated:

$$E = \frac{1}{{ND}^{2}} {\sum }_{i = 1}^{N} {( {x}_{i} - \overline{x} )}^{4} - 3.$$

where xᵢ is the size of the i^{th} packet, x̅ is the arithmetic average value of the sizes of the packets, and N is the quantity of the sizes of the packets.

(7) Skewness of the sizes of the packets is used to indicate a leaning direction and degree of the distribution form of the sizes of the packets.

A formula for calculating skewness is:

$${S}_{k} = \frac{{μ}_{3}}{{σ}^{3}} , and {μ}_{3} = \frac{1}{N} \sum {( {x}_{i} - \overline{x} )}^{3} ,$$

where Sₖ is skewness, μ₃ is a three-order central moment, σ is a standard deviation. N is the total quantity of the sizes of the packets, xᵢ is the size of the i^{th} packet, and x̅ is the arithmetic average value of the sizes of the packets.

(8) The spectrum parameter about the sizes of the packets is a ratio of a quantity of packets in a preset interval to the total quantity of the sizes of the packets. A formula for calculating the spectrum parameter about the sizes of the packets is as follows:

Pᵢ=Nᵢ/N,

where Pᵢ is a value of a spectrum parameter about sizes of packets in an i^{th} value interval, Nᵢ is a quantity of the sizes of the packets included in the i^{th} value interval, and N is the total quantity of the sizes of the packets.

For example, the total quantity of the sizes of the packets is 10, and a preset interval of the sizes of the packets is (230 bytes, 270 bytes). If sizes of five packets are in (230 bytes, 270 bytes), a value of a spectrum parameter about the sizes of the packets in the value interval is P=5/10=0.5.

It should be noted that, for M data streams and N packets, reception time intervals of (N−M) packets may be obtained. A method for calculating a statistical parameter about the reception time intervals of the (N−M) packets is similar to the method for calculating the statistical parameter about the sizes of the N packets. The first time period may be divided into P unit times. A packet transmission rate within each unit time may be determined based on an amount of data within the unit time. A method for calculating a statistical parameter about transmission rates of P packets is similar to the method for calculating the statistical parameter about the sizes of the N packets.

Step 403: Determine, based on the target feature set and a correspondence between the target feature set and a service type, a service type corresponding to the first data stream in the first time period.

Specifically, a feature library includes a plurality of feature sets, where each feature set corresponds to one service type, and one service type may correspond to one feature set or may correspond to a plurality of feature sets.

The traffic detection device may obtain the feature library locally or from a network storage server. When the target feature set is a feature set in the feature library, it is determined, based on the target feature set and the correspondence between the target feature set and the service type, that the service type corresponding to the first data stream in the first time period is the service type corresponding to the target feature set.

When the feature library does not include the target feature set, the feature library is searched for a first feature set having a highest similarity with the target feature set among feature sets in the feature library, and then a service type corresponding to the first feature set is used as the service type corresponding to the first data stream in the first time period. Alternatively, after the feature library is searched for a feature set having a similarity with the target feature set higher than a preset threshold, a service type corresponding to the found feature set is used as the service type corresponding to the first data stream in the first time period. In an optional implementation, after the target feature set is obtained, an identifier used to indicate a service type is determined and output based on a correspondence between the target feature set and the identifier used to indicate the service type. After the identifier is obtained, the service type is determined based on the identifier.

It should be noted that, after the traffic collection device collects the packets, the traffic detection device may immediately perform the traffic detection method on the collected packets to perform real-time analysis. Alternatively, after collecting the packets, the traffic collection device stores the collected packets in a local storage server or a network storage server; and the traffic detection device reads the packets from the storage server, and then performs the traffic detection method on the read packets to perform offline analysis.

In this embodiment, to determine a service type of a data stream, a multi-stream feature is extracted from packets in the data stream and at least one other data stream that belongs to a same user as the data stream. Because impact of other data streams of the same user on the data stream can be considered in the multi-stream feature, the data stream can be described more accurately, and accuracy of traffic detection on the data stream can be improved.

Duration of selecting packets by the traffic detection device from the plurality of data streams may be a fixed duration, or may be a variable duration. The following describes in detail a non-limiting, example process of selecting packets by using a variable duration.

In an optional embodiment, step 401 is specifically: obtaining a plurality of packets collected by the traffic collection device in a second time period; and if a time difference between a time of receiving a last packet in the first data stream by the traffic collection device in the second time period and an end time of the second time period is less than a preset threshold, obtaining a plurality of packets collected by the traffic collection device in a third time period, where if the time difference between the time of receiving the last packet in the first data stream by the traffic collection device in the second time period and the end time of the second time period is not less than the preset threshold, the second time period is the same as the first time period.

Specifically, the plurality of packets collected in the second time period include packets in the first data stream and the at least one other data stream. A start time of the second time period is a start time of the first time period, and the second time period is a part of the first time period. A sum of the second time period and the third time period is the first time period.

If the time difference between the time of receiving the last packet in the first data stream by the traffic collection device in the second time period and the end time of the second time period is less than the preset threshold, it indicates that the packets transmitted in the second time period may be a part of data of a data transmission task. Therefore, the traffic detection device adds the third time period on a basis of the second time period, and uses the packets obtained in the second time period and the third time period as the packets obtained in the first time period. Because the packets obtained in the third time period are added, that is, more packets are obtained for traffic analysis, a message sequence obtained through collection is more complete. Duration of the third time period is not limited in embodiments of the present disclosure. The duration of the third time period may include but is not limited to 5 seconds, 10 seconds, 30 seconds, or the like.

If the time difference between the time of receiving the last packet in the first data stream by the traffic collection device in the second time period and the end time of the second time period is greater than or equal to the preset threshold, it indicates that the data transmission task is already completed in the second time period. This indicates that the plurality of packets collected in the second time period can satisfy a traffic identification requirement, and the time period may not be prolonged. In this case, the second time period is the same as the first time period.

FIG. 5a is a schematic diagram for obtaining packets in an expanded time window according to an embodiment of the present disclosure. In a process of obtaining, for the first time, packets used for traffic detection, a second time period is [0, 10 s], and a preset time is 1 s. If a time of receiving a last packet in [0, 10 s] is 9.8 s, a difference between the time of receiving the last packet and 10 s is 0.2 s. Because 0.2 s is less than 1 s, packets in a third time period [10 s, 15 s] are obtained, and packets received in [0, 15 s] are used as packets obtained in a first time period in the process of obtaining, for the first time, the packets used for traffic detection.

FIG. 5b is a schematic diagram for obtaining packets in a non-expanded time window according to an embodiment of the present disclosure. When packets used for traffic detection are obtained for the second time, a second time period is [10 s, 20 s], and a preset time is 1 s. First, packets in [10 s, 20 s] are obtained. If a time of receiving a last packet in [10 s, 20 s] is 17 s, a difference between the time of receiving the last packet and 20 s is 3 s. Because 3 s is greater than 1 s, the packets in [10 s, 20 s] are obtained as packets obtained in a first time period in the process of obtaining, for the second time, the packets used for traffic detection. Therefore, an overlapping time difference exists between the two processes of consecutively obtaining packets. When traffic detection is performed in this manner, all packets that pass through the traffic detection device in the foregoing process can be processed. In addition, as can be seen from above, the tenth second is an end time of the second time period in the process of obtaining, for the first time, the packets used for traffic detection, and is also a start time of the first time period in the process of obtaining, for the second time, the packets used for traffic detection. Therefore, a later time period may be used to search for an earlier time period.

For a long-time service or a large-traffic service, a more complete message sequence can be obtained from a data stream by adjusting duration of collecting packets. In comparison with a feature extracted from a message sequence segment, a feature extracted from a complete message sequence is more accurate, and therefore accuracy of traffic detection can be improved.

In another optional embodiment, step 401 is specifically: obtaining a plurality of packets collected by the traffic collection device in a second time period; and if a total amount of data received by the traffic collection device in the second time period is greater than a preset data amount, obtaining a plurality of packets collected by the traffic collection device in a third time period, where a sum of the second time period and the third time period is the first time period, and if the total amount of the data received by the traffic collection device in the second time period is not greater than the preset data amount, the second time period is the same as the first time period.

In this embodiment, the plurality of packets collected in the second time period include packets in the first data stream and the at least one other data stream in the second time period.

If the total amount of the data received in the second time period is greater than the preset data amount, it indicates that the data amount in the second time period is relatively large, and the data transmitted in the second time period may be a part of data of a data transmission task. Therefore, the traffic detection device adds the third time period on a basis of the second time period to obtain more packets, so that a message sequence obtained through collection is more complete. Duration of the third time period is not limited in embodiments of the present disclosure. The duration of the third time period includes but is not limited to 5 seconds, 10 seconds, or 30 seconds.

If the total amount of the data received in the second time period is not greater than the preset data amount, it indicates that the data transmission task is already completed in the second time period. Therefore, the plurality of packets selected in the second time period can satisfy a traffic identification requirement, and the time period may not be prolonged. In this case, the second time period is the same as the first time period.

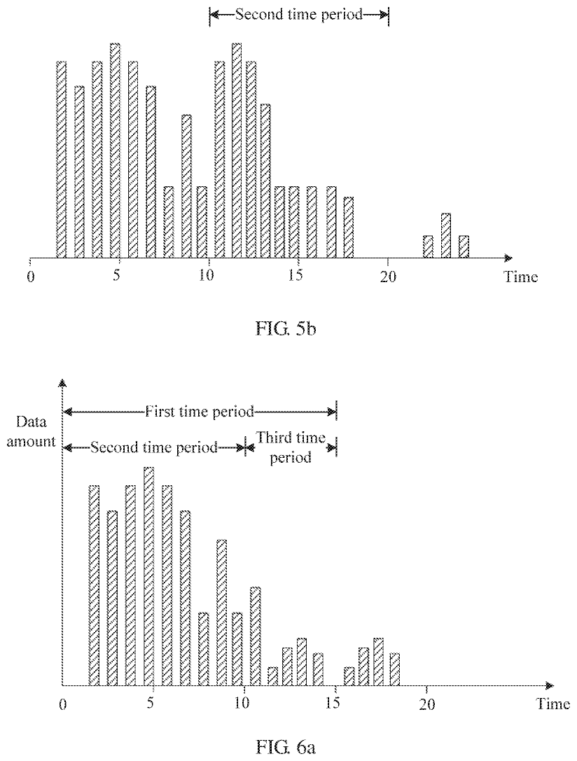

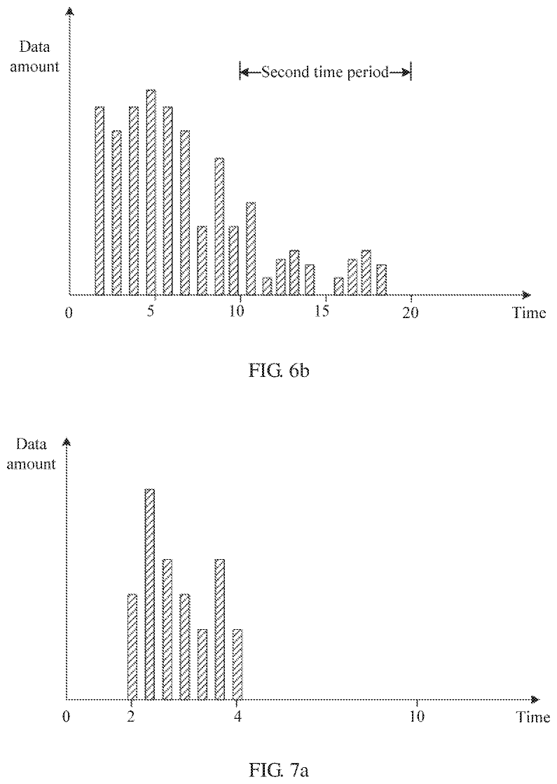

FIG. 6a is another schematic diagram for obtaining packets in an expanded time window according to an embodiment of the present disclosure. For example, a second time period is [0, 10 s], and a preset data amount is 3 megabytes (MB). If a total amount of data of packets received in [0, 10 s] is 5 MB, because 5 MB is greater than 3 MB, packets in a third time period [15 s, 20 s] are obtained, and the packets obtained in [0, 15 s] are used as packets obtained in a first time period.

FIG. 6b is another schematic diagram for obtaining packets in a non-expanded time window according to an embodiment of the present disclosure. When packets used for traffic detection are obtained next time, first, packets in [10 s, 20s] are obtained; and if a total amount of data of packets received in [10 s, 20s] is 1 MB, because 1 MB is less than 3 MB, the packets obtained in [10 s, 20s] are used as packets obtained in a first time period.

For a long-time service or a large-traffic service, the traffic detection device in this embodiment can obtain a more complete message sequence from a data stream by adjusting a sampling duration. In comparison with a feature extracted from a message sequence segment, a feature extracted from a complete message sequence is more accurate, and therefore accuracy of traffic detection can be improved.

In another optional embodiment, step 403 includes: finding a first feature set in a feature library based on the target feature set, where the first feature set is a feature set having a highest similarity with the target feature set among feature sets in the feature library; and determining, based on a correspondence between the first feature set and a service type, the service type corresponding to the first data stream in the first time period, where the service type corresponding to the first data stream in the first time period is the same as the service type corresponding to the first feature set.

In this embodiment, the feature library includes a plurality of feature sets, where each feature set corresponds to one service type. Specifically, one service type may correspond to one or more feature sets. A feature set in the feature library may be preset, or may be added to the feature library after it is determined through detection that the feature set satisfies a preset condition.

The similarity is a degree of similarity between feature values in two feature sets that are compared, and a value of the similarity may be obtained through calculation by using a similarity formula. The similarity formula includes but is not limited to a Euclidean distance formula, a Manhattan distance formula, an angle cosine formula, or a Pearson correlation coefficient. The preset threshold is used to measure whether two objects that are compared are similar. A value of the preset threshold may be set based on an actual situation, for example, to 80%. If the similarity exceeds the preset threshold, it is determined that the two objects that are compared are similar; or if the similarity does not exceed the preset threshold, it is determined that the two objects that are compared are not similar.

For example, a feature included in a feature set is an average value of sizes of packets. A feature value in the target feature set is 220 bytes, and the target feature set is marked with A1. The feature library includes three feature sets, which are marked with A2, A3, and A4 respectively. Feature values in A2, A3, and A4 are 200 bytes, 500 bytes, and 1000 bytes respectively. First, 220 bytes, 200 bytes, 500 bytes, and 1000 bytes are normalized by using 1000 bytes, to obtain 0.22, 0.2, 0.5, and 1, and then the similarity formula is used to calculate similarities between A1 and A2, between A1 and A3, and between A1 and A4 separately.

The similarity formula is: Similarity between X and Y=1/(1+Distance(X, Y)), where Distance(X, Y) indicates a Euclidean distance between X and Y. X and Y each may include a feature value or a group of feature values.

Calculation results are respectively as follows:

Similarity between A1 and A2=1/(1+|0.22−0.2|)≈0.98;

Similarity between A1 and A3=1/(1+|0.5−0.2|)≈0.77; and

Similarity between A1 and A4=1/(1+|1−0.2|)≈0.56.

Based on a comparison result of 0.98>0.77>0.56, it can be known that a value of the similarity between A1 and A2 is the largest. To be specific, the similarity between the feature set A2 in the feature library and the target feature set A1 is the highest.

If X and Y each include a group of feature values, where a group of feature values included in X are marked with (x1, x2, x3, x4, x5), and a group of feature values included in Y are marked with (y1, y2, y3, y4, y5), in the foregoing similarity formula:

Distance(X,Y)=\sqrt{(x1−y1)²+(x2−y2)²+(x3−y3)²+(x4−y4)²+(x5−y5)²}.

It should be noted that, types of two compared features in two feature sets are the same. To be specific, feature types of x1 and y1 are the same, feature types of x2 and y2 are the same, feature types of x3 and y3 are the same, feature types of x4 and y4 are the same, and feature types of x5 and y5 are the same.

In another optional embodiment, the traffic detection method further includes: training a plurality of new samples and a plurality of historical samples by using a machine learning algorithm, to update a correspondence between a feature set and a service type in the feature library, where the plurality of new samples include a sample corresponding to the first data stream in the first time period, and the sample corresponding to the first data stream includes a multi-stream feature and the service type of the first data stream.

The sample may be a table. In the table, each row or each record may record information about the sample, including various features of the data stream and the service type of the data stream. For example, one sample may include N multi-stream features, M single-stream features, and features of L transactions; or one sample includes N multi-stream features and M single-stream features; or one sample includes N multi-stream features and features of L transactions. N, M, and L are positive integers, and their values may be the same or may be different. The values are not limited in embodiments of the present disclosure. In the correspondence between a feature set and a service type that is obtained after machine learning, features that are included are a universal set or a subset of feature sets of the samples. Actually, the features are usually a subset. It may be understood that, for features included in the feature sets of the samples, reference may be made to the corresponding descriptions in the foregoing embodiments. The features are not limited in embodiments of the present disclosure.

In this embodiment, the historical samples are samples that are obtained before the new samples are obtained. The historical samples may be preset or may be samples generated after traffic detection. The machine learning algorithm includes but is not limited to: a decision tree algorithm, a random forest algorithm, a logistic regression algorithm, a support vector machine (SVM) algorithm, a Naive Bayes algorithm, a K-means algorithm, an Adaboost algorithm, a Markov algorithm, or the like.

After step 403, the multi-stream feature and the service type that correspond to the first data stream may be used as a new sample. By using the foregoing method, another new sample may be further obtained in a subsequent time period, or a multi-stream feature and a service type that correspond to the other data stream are used as a new sample. After that, a plurality of new samples and a plurality of historical samples are trained by using the machine learning algorithm, to update a correspondence between a feature set and a service type. It should be noted that, a feature set in a sample includes but is not limited to a multi-stream feature, and may further include a single-stream feature, a transaction feature, or the like.

Because the generated new samples and the historical samples are trained together, the correspondence between a feature set and a service type can be updated and corrected, and the updated correspondence between a feature set and a service type is closer to the current correspondence between a data stream and a service type and can also be more diversified. By using the updated correspondence between a feature set and a service type during identification, on one hand, more data streams can be identified, and on the other hand, accuracy of traffic detection can also be improved. In addition, because the correspondence between a feature set and a service type is updated in real time, a service type of a new data stream in an embodiment can be accurately identified. This can resolve a problem that a new data stream cannot be accurately identified based on an offline sample training method.

It should be noted that, a plurality of thresholds may be further set in embodiments of this application. For example, a first threshold is 80%, a second threshold is 60%, a feature set having confidence higher than 80% is a high-confidence feature set, a feature set having confidence in the range of [60%, 80%] is a medium-confidence feature set, and a feature set having confidence lower than 60% is a low-confidence feature set.

In the method disclosed above, the service type corresponding to the feature set having the highest similarity is used as the service type corresponding to the target feature set. However, in some cases, although a similarity between two feature sets is highest, the similarity is lower than a preset similarity threshold, for example, 60%, the two feature sets are not considered to be similar in an embodiment. If a low-confidence sample and a high-confidence sample are trained, accuracy of an updated correspondence between a feature set and a service type becomes low. To resolve this problem, example embodiments of this application provide a plurality of methods for selecting new samples, to remove low-confidence samples from the new samples and ensure that all samples that are trained are high-confidence samples. The following provides detailed descriptions.

In an optional embodiment, at least one first new sample is included in the plurality of new samples, the first new sample corresponds to a feature set in the feature library, the first new sample includes a group of high-confidence features, a similarity between the group of high-confidence features and the feature set in the feature library satisfies a preset condition, and a service type included in the first new sample is the same as a service type corresponding to the feature set corresponding to the first new sample.

In this embodiment, types of features included in the target feature set and the first feature set are the same.

After the target feature set corresponding to the first data stream is determined, the feature library is searched for the first feature set having the highest similarity with the target feature set among feature sets in the feature library. Whether the similarity between the target feature set and the first feature set is not lower than a preset similarity threshold is determined; and if the similarity is not lower than the preset similarity threshold, the target feature set is determined as a high-confidence feature set, and the target feature set and the service type corresponding to the first feature set are used as a first new sample; or if the similarity is lower than the preset similarity threshold, the target feature set is determined as a low-confidence feature set, and the feature set and the service type corresponding to the feature set are not used as a sample. In this way, a high-confidence feature set and a service type corresponding to the high-confidence feature set are used as a new sample, and using a sample including a low-confidence feature set as a training sample is avoided.

In another optional embodiment, at least one other new sample is included in the plurality of new samples, and the method further includes: obtaining a server identity that corresponds to a data stream collected by the traffic collection device in a time period, where the server identity includes an Internet Protocol (IP) address of a server and a name of the server, determining a service type of the data stream based on a correspondence between the server identity and a service type; and storing a second new sample corresponding to the data stream, where the second new sample includes the service type and a multi-stream feature of the data stream in the time period.

In this embodiment, the traffic detection device may parse a packet header to obtain the server identity, and the server identity includes but is not limited to the Internet Protocol (IP) address of the server and the server name. The server name (e.g., Server Name Indication, SNI) is information that is obtained by parsing an encryption handshake message, or http.host information (such as a domain name) that is obtained by parsing an HTTP header.

For example, a correspondence between a service type, an IP feature, and an SNI feature is shown in Table 2:

TABLE 2

| Service | | |
|---|---|---|
| type | IP Address | SNI |
| Web | 115.231.171.50 | huawei.com |
| Web | 202.89.233.100 | bing.com |
| Video | 106.11.47.19 | youku.com |
| Video | 31.13.97.245 | youtube.com |

When the IP address of the server is 115.231.171.50, and the server name is huawei.com, the service type corresponding to the first data stream in the first time period is determined as a web service.

A plurality of packets in the first data stream and the second data stream are obtained in a time period, and after a multi-stream feature and the web service corresponding to the plurality of packets are determined, the multi-stream feature and the web service are used as a second new sample for storage. In an embodiment, some servers provide only one type of service. Therefore, the type of the service provided by the server can be identified rapidly by using the server identity.

In an embodiment, a server corresponding to the server identity including an IP address and a server name may provide one or more services. In this way, a server identity including an IP address and a server name may correspond to one or more service types.

In another implementation, the traffic detection device obtains a plurality of records and service types corresponding to one server identity in a time period, calculates a quantity of records corresponding to each service type, calculates a ratio of the quantity of records corresponding to each service type to a total quantity of records, and determines a service type with a largest ratio as a service type corresponding to the server identity in the time period. The record corresponding to the server identity is one or more packets transmitted in a time period by a server corresponding to the server identity.

For example, for a group of IP addresses and server names, there are 15 records in total in a time period, where a quantity of records corresponding to a service type 1 is 4, a quantity of records corresponding to a service type 2 is 5, and a quantity of records corresponding to a service type 3 is 6. Obviously, in the time period, a probability that the group of IP addresses and server names corresponds to the service type 1 is 4/15≈0.27, a probability that the group of IP addresses and server names corresponds to the service type 2 is 5/15≈0.33, and a probability that the group of IP addresses and server names corresponds to the service type 3 is 6/15=0.4. 0.4 is the largest, which indicates that a quantity of packets whose service types are the service type 3 is the largest. Therefore, the service type corresponding to the group of IP addresses and server names in the time period is the service type 3.

In another example, for a group of IP addresses and server names, there are 10 records in total in a time period, where a service type corresponding to the 10 records is a service type 1. Obviously, a probability that the group of IP addresses and server names corresponds to the service type 1 is 1. Therefore, the service type corresponding to the group of IP addresses and server names in the time period is the service type 1.

In another optional embodiment, the traffic detection method further includes: when a reception time period of a first message sequence overlaps a reception time period of a second message sequence, the traffic detection device determines that the service type corresponding to the first data stream in the first time period is a web browsing service.

The first message sequence is a plurality of packets that belong to the first data stream in the first time period. The second message sequence is a plurality of packets that belong to the second data stream in the first time period. The first data stream and the second data stream are different data streams of the same user.

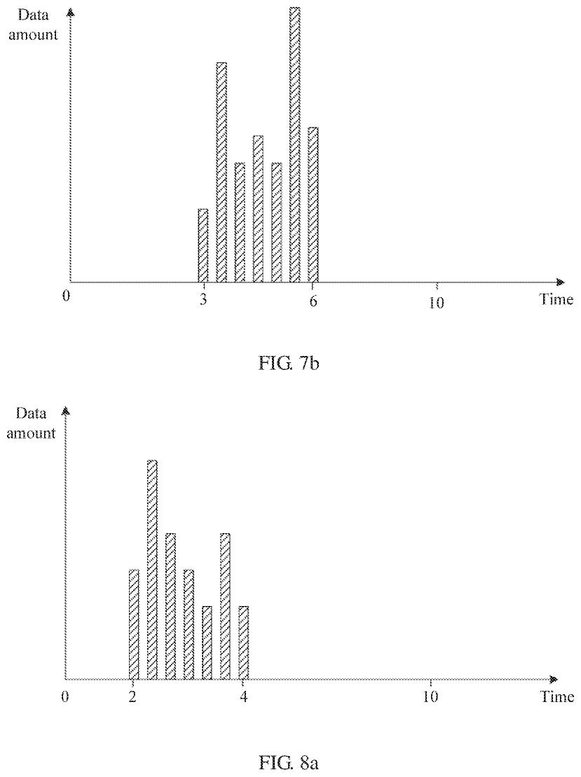

For details, refer to FIG. 7a and FIG. 7b. FIG. 7a is a schematic diagram of the first message sequence according to an embodiment of the present disclosure. FIG. 7b is a schematic diagram of the second message sequence according to an embodiment of the present disclosure. The first time period is 0-10 seconds, a reception time period of the first message sequence is 2-4 seconds, and a reception time period of the second message sequence is 3-6 seconds. Because the reception time period of the first message sequence overlaps the reception time period of the second message sequence, it may be determined that a service of the user in the first time period is the web browsing service.

In another optional embodiment, the traffic detection method further includes: when a reception time period of a first message sequence does not overlap a reception time period of a second message sequence, and a difference between an amount of data in the first message sequence and an amount of data in the second message sequence is less than a preset difference, the traffic detection device determines that the service type corresponding to the first data stream in the first time period is an online video service.

The first message sequence is a plurality of packets that belong to the first data stream in the first time period. The second message sequence is a plurality of packets that belong to the second data stream in the first time period. The first data stream and the second data stream are different data streams of the same user.

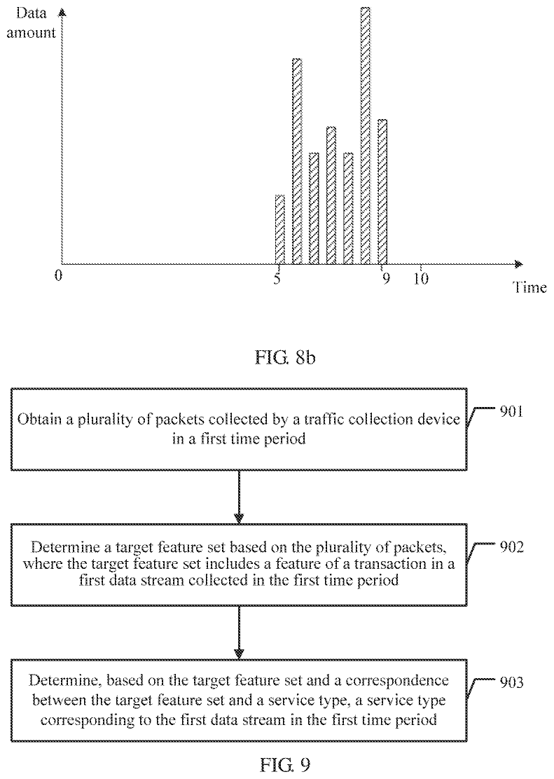

For details, refer to FIG. 8a and FIG. 8b. FIG. 8a is a schematic diagram of the first message sequence according to an embodiment of the present disclosure. FIG. 8b is a schematic diagram of the second message sequence according to an embodiment of the present disclosure. The first time period is 0-10 seconds, a reception time period of the first message sequence is 2-4 seconds, a reception time period of the second message sequence is 5-9 seconds, an amount of data in the first message sequence is 10 MB, an amount of data in the second message sequence is 10.5 MB, and a preset difference is 2 MB. In this case, because the reception time period of the first message sequence does not overlap the reception time period of the second message sequence, and a difference between the amount of data in the first message sequence and the amount of data in the second message sequence is less than the preset difference, it may be determined that a service of the user in the first time period is the online video service.

For ease of understanding, the following describes, in detail by using a plurality of specific application scenarios, a traffic detection method provided in this application.

In a first specific application scenario, a traffic detection device determines three data streams of a same user based on an IP address. An initial sampling time period is 0-10 seconds. 200 packets are collected in a first data stream, 300 packets are collected in a second data stream, and 500 packets are collected in a third data stream. A total quantity of collected packets is 1000.

For example, a preset data amount is 10 MB, and an amount of data in the 1000 collected packets is 220 KB. Because the amount of data in the packets collected in the initial sampling time period does not exceed 10 MB, the traffic detection device does not prolong the sampling time period. Therefore, the traffic detection device determines, based on the 1000 packets collected in 0-10 seconds, a target feature set corresponding to the packets.

As shown in Table 3, the target feature set may include but is not limited to statistical parameters shown in Table 3. A mapping relationship between a multi-stream feature and a service type includes a multi-stream feature set 1 and a multi-stream feature set 2, where a service type corresponding to the multi-stream feature set 1 is a web browsing service, and a service type corresponding to the multi-stream feature set 2 is an online video service.

TABLE 3

| | Target | | |
|---|---|---|---|
| | feature | Multi-stream | Multi-stream |
| | set | feature set 1 | feature set 2 |
| Average value of sizes of | 220 bytes | 200 bytes | 1000 bytes |
| packets | | | |
| Maximum value of sizes | 240 bytes | 220 bytes | 1020 bytes |
| of packets | | | |
| Minimum value of sizes | 200 bytes | 180 bytes | 980 bytes |
| of packets | | | |
| Standard deviation of sizes | 28 | 28 | 28 |
| of packets | | | |
| Median of sizes of packets | 220 bytes | 200 bytes | 1000 bytes |

For the example in Table 3, the following feature sets are obtained after each feature set is normalized by using 1500 bytes:

Target feature set: X=[220, 240, 200, 28, 220]/1500=[0.146667, 0.16, 0.133333, 0.018667, 0.146667].

Multi-stream feature set 1: Y1=[200, 220, 180, 28, 200]/1500=[0.133333, 0.146667, 0.12, 0.018667, 0.133333].

Multi-stream feature set 2: Y2=[1000, 1020, 980, 28, 1000]/1500=[0.666667, 0.68, 0.653333, 0.018667, 0.666667].

A similarity between X and Y1 is calculated by using a similarity formula, for example, Similarity=1/(1+Distance(X, Y)). Assuming that a preset similarity is 0.6, the similarity between X and Y1 is equal to 0.974, indicating that X and Y1 are similar. A similarity between X and Y2 is equal to 0.49, indicating that X and Y2 are not similar. Therefore, a service type corresponding to the target feature set is the same as the service type corresponding to the multi-stream feature set 1, that is, the web browsing service.

In addition, {220 bytes, 240 bytes, 200 bytes, 28, 220 bytes} included in the target feature set and the web browsing service are used as a new sample, and the new sample is stored. It may be understood that, in a subsequent traffic detection process, the target feature set may be used as an object for comparison. If a subsequent feature set is the same as or similar to the target feature set, it is determined that a service type corresponding to the subsequent feature set is the web browsing service. Alternatively, an updated sample set is trained based on a machine learning algorithm, and a subsequent packet is detected by using a correspondence between a feature set and a service type that is obtained by training.

In a second specific application scenario, a traffic detection device determines three data streams of a same user based on an IP address. An initial sampling time period is 0-10 seconds. 2000 packets are collected in a first data stream, 3000 packets are collected in a second data stream, and 5000 packets are collected in a third data stream. A total quantity of collected packets is 10000.

For example, a preset data amount is 10 MB, and an amount of data in the 10000 collected packets is 12 MB. Because the amount of data in the packets collected in the sampling time period exceeds 10 MB, the traffic detection device prolongs the sampling time period by 5 seconds, that is, the sampling time period is 0-15 seconds. For example, a total quantity of packets collected in 10-15 seconds is 5000, and an amount of data in the 5000 packets is 6 MB. Therefore, the traffic detection device determines, based on the 15000 packets collected in the 0-15 seconds, a target feature set corresponding to the packets.

As shown in Table 4, the target feature set may include but is not limited to statistical parameters shown in Table 4. A mapping relationship between a multi-stream feature and a service type includes a multi-stream feature set 1 and a multi-stream feature set 2, where a service type corresponding to the multi-stream feature set 1 is a web browsing service, and a service type corresponding to the multi-stream feature set 2 is an online video service.

TABLE 4

| | Target | | |
|---|---|---|---|
| | feature | Multi-stream | Multi-stream |
| | set | feature set 1 | feature set 2 |
| Average value of sizes of | 1200 bytes | 200 bytes | 1000 bytes |
| packets | | | |
| Maximum value of sizes | 1400 bytes | 220 bytes | 1100 bytes |
| of packets | | | |
| Minimum value of sizes | 1000 bytes | 180 bytes | 900 bytes |
| of packets | | | |
| Standard deviation of sizes | 28 | 28 | 28 |
| of packets | | | |
| Median of sizes of packets | 1200 bytes | 200 bytes | 1000 bytes |

For the example in Table 4, the following feature sets X, Y1, and Y2 are obtained respectively after the target feature set, the multi-stream feature set 1, and the multi-stream feature set 2 are normalized by using 1500 bytes:

X=[1200, 1400, 1000, 28, 1200]/1500=[0.8, 0.933333, 0.666667, 0.018667, 0.8];

Y1=[200, 220, 180, 28, 200]/1500=[0.133333, 0.146667, 0.12, 0.018667, 0.133333]:

and

Y2=[1000, 1100, 980, 28, 1000]/1500=[0.666667, 0.733333, 0.6, 0.018667, 0.666667].

A similarity between X and Y1 is calculated by using a similarity formula, for example, Similarity=1/(1+Distance(X, Y)). Assuming that a preset similarity is 0.6, the similarity between X and Y1 is equal to 0.426, indicating that X and Y are not similar. A similarity between X and Y2 is equal to 0.726, indicating that X and Y2 are similar. Therefore, a service type corresponding to the target feature set is the same as the service type corresponding to the multi-stream feature set 2, that is, the online video service.

In addition, {1200 bytes, 1400 bytes, 1000 bytes, 28, 1200 bytes} included in the target feature set in Table 4 and the online video service are used as a new sample, and the new sample is added to a sample set. It may be understood that, in subsequent traffic detection, the new sample may be used as an object for comparison. If a subsequent feature set is the same as or similar to the target feature set, it is determined that a service type corresponding to the subsequent feature set is the online video service. Alternatively, the sample set is trained based on a machine learning algorithm, and a subsequent packet is detected by using a correspondence between a feature set and a service type that is obtained by training.

For a plurality of data streams of a same user, in addition to a multi-stream feature, the traffic detection device may further obtain a single-stream feature and a transaction feature from a data stream to determine a service type of the data stream more accurately. In embodiments of this application, traffic detection may be performed with reference to the multi-stream feature, the single-stream feature, and/or the transaction feature. The following provides detailed descriptions. For steps and descriptions corresponding to the foregoing implementation, refer to the foregoing descriptions.

I. Performing Traffic Detection Based on a Multi-Stream Feature and a Single-Stream Feature:

Another example traffic detection method provided in an embodiment of this application includes: obtaining a plurality of packets collected by a traffic collection device in a first time period; determining a target feature set based on the plurality of packets, where the target feature set includes a multi-stream feature corresponding to the plurality of packets and a single-stream feature corresponding to a plurality of packets collected in a first data stream in the first time period; and determining, based on the target feature set and a correspondence between the target feature set and a service type, a service type corresponding to the first data stream in the first time period.

In this embodiment, the plurality of packets include packets in the first data stream and at least one other data stream associated with the first data stream. The first data stream and the at least one other data stream are data streams of a same user.

The single-stream feature includes a statistical parameter about sizes of the collected packets in the first data stream. Optionally, the single-stream feature further includes at least one of a statistical parameter about reception time intervals of the collected packets in the first data stream or a statistical parameter about transmission rates thereof, where the reception time interval is a reception time interval between any two consecutively received packets in the collected packets in the first data stream. The statistical parameter includes at least one of an average value, a maximum value, a minimum value, a standard deviation, a quantile, kurtosis, skewness, or a spectrum parameter.

The determining a target feature set based on the plurality of packets includes: determining, based on the plurality of packets obtained from the first data stream and the second data stream in the first time period, the multi-stream feature corresponding to the plurality of packets; and determining, based on the plurality of packets included in the first data stream collected in the first time period, the single-stream feature corresponding to the first data stream in the first time period.

Specifically, for a specific method for determining, based on the plurality of packets obtained from the first data stream and the second data stream in the first time period, the multi-stream feature corresponding to the plurality of packets, refer to step 402 in the embodiment shown in FIG. 4.

A specific method for determining, based on the plurality of packets included in the first data stream collected in the first time period, the single-stream feature corresponding to the first data stream in the first time period is similar to the method for determining the multi-stream feature from the plurality of packets in step 402. For example, the first data stream in the first time period includes M packets. For the M packets, sizes of the M packets are obtained, and then an average value of the sizes of the M packets is calculated as a single-stream feature corresponding to the first data stream. Similarly, an average value of reception time intervals of the M packets may be calculated as another single-stream feature corresponding to the first data stream. An average value of transmission rates of the M packets may be calculated as another single-stream feature corresponding to the first data stream.

In this embodiment, when searching a feature library for a similar feature set, a traffic detection device not only needs to compare multi-stream features, but also needs to compare single-stream features. In comparison with identification of a service type of a data stream based on only a multi-stream feature, more features can be used in this embodiment to describe the data stream more completely and accurately. When a service is identified, features in more dimensions are required, and therefore accuracy of data stream identification is improved.

In addition, the traffic detection device may determine, based on the multi-stream feature and the single-stream feature, the service type corresponding to the first data stream. Therefore, a new method for identifying a data stream is provided and has good feasibility.

II. Performing Traffic Detection Based on a Multi-Stream Feature and a Transaction Feature:

Another example traffic detection method provided in another embodiment of this application includes: obtaining a plurality of packets collected by a traffic collection device in a first time period; determining a target feature set based on the plurality of packets, where the target feature set includes a multi-stream feature corresponding to the plurality of packets and a feature of a transaction in a first data stream collected in the first time period; and determining, based on the target feature set and a correspondence between the target feature set and a service type, a service type corresponding to the first data stream in the first time period.

In this embodiment, the plurality of packets are a plurality of packets collected from the first data stream and at least one other data stream in the first time period. For the first data stream and the at least one other data stream, refer to the related descriptions of the embodiment shown in FIG. 4.

The transaction includes a plurality of packets in the data stream, the plurality of packets included in the transaction are a request and at least one response corresponding to the request, and the feature of the transaction includes a statistical parameter about sizes of the plurality of packets included in the transaction. Optionally, the feature of the transaction further includes a statistical parameter about reception time intervals corresponding to the plurality of packets included in the transaction and a statistical parameter about transmission rates of the plurality of packets included in the transaction. For example, if a user searches for a keyword A and a keyword B separately by using a Google application program, a search request sent by the user to a Google server and including the keyword A and a response sent by the Google server with respect to the search request including the keyword A form a transaction. Likewise, a search request sent by the user to the Google server and including the keyword B and a response sent by the Google server with respect to the search request including the keyword B from another transaction.

The determining a target feature set based on the plurality of packets specifically includes: determining, based on the plurality of packets obtained from the first data stream and the second data stream in the first time period, the multi-stream feature corresponding to the plurality of packets; and determining, based on the plurality of packets included in the transaction in the first data stream collected in the first time period, the feature of the transaction in the first data stream in the first time period.

Specifically, for a specific method for determining, based on the plurality of packets obtained from the first data stream and the second data stream in the first time period, the multi-stream feature corresponding to the plurality of packets, refer to step 402 in the embodiment shown in FIG. 4.

A specific method for determining, based on the plurality of packets included in the transaction in the first data stream collected in the first time period, the feature of the transaction in the first data stream collected in the first time period is similar to the method for determining the multi-stream feature from the plurality of packets in step 402. For example, the first data stream in the first time period includes a plurality of transactions, and a quantity of packets included in an i^{th} transaction in the plurality of transactions is Nᵢ. For the Nᵢ packets included in the i^{th} transaction, sizes of the Nᵢ packets are obtained, and then an average value of the sizes of the Nᵢ packets is calculated as a transaction feature of a transaction in the first data stream.

In this embodiment, when searching a feature library for a similar feature set, a traffic detection device not only needs to compare multi-stream features, but also needs to compare transaction features. In comparison with identification of a service type of a data stream based on only a multi-stream feature, more features can be used in this embodiment to indicate the data stream more completely and accurately. When a service is identified, features in more dimensions are required, and therefore accuracy of data stream identification is improved.

III. Performing Traffic Identification Based on a Multi-Stream Feature, a Single-Stream Feature, and a Transaction Feature:

Another example traffic detection method provided in yet another embodiment this application includes: obtaining a plurality of packets collected by a traffic collection device in a first time period; determining a target feature set based on the plurality of packets, where the target feature set includes a multi-stream feature corresponding to the plurality of packets, a single-stream feature corresponding to a first data stream in the first time period, and a transaction feature corresponding to a transaction in the first data stream in the first time period: and determining, based on the target feature set and a correspondence between the target feature set and a service type, a service type corresponding to the first data stream in the first time period.

In this embodiment, the plurality of packets include packets in the first data stream and at least one other data stream associated with the first data stream. For the first data stream, the at least one other data stream, the transaction, the multi-stream feature, the single-stream feature, and the transaction feature, refer to the foregoing embodiments.

The determining a target feature set based on the plurality of packets specifically includes: determining, based on the plurality of packets obtained from the first data stream and the other data stream in the first time period, the multi-stream feature corresponding to the plurality of packets; determining, based on a plurality of packets included in the first data stream collected in the first time period, the single-stream feature corresponding to the first data stream collected in the first time period; and determining, based on a plurality of packets included in the transaction in the first data stream collected in the first time period, the transaction feature corresponding to the transaction in the first data stream collected in the first time period.

Specifically, for a specific method for determining, based on the plurality of packets obtained from the first data stream and the second data stream in the first time period, the multi-stream feature corresponding to the plurality of packets, refer to step 402 in the embodiment shown in FIG. 4. For a specific method for determining, based on the plurality of packets included in the first data stream collected in the first time period, the single-stream feature corresponding to the first data stream in the first time period, refer to the foregoing embodiments. For a specific method for determining, based on the plurality of packets included in the transaction in the first data stream collected in the first time period, the feature of the transaction in the first data stream collected in the first time period, refer to the foregoing embodiments.

In this embodiment, when searching a feature library for a similar feature set, a traffic detection device not only needs to compare multi-stream features, but also needs to compare single-stream features and transaction features. In comparison with identification of a service type of a data stream based on only a multi-stream feature or a single-stream feature, more features can be used in this embodiment to indicate the data stream more completely and accurately. When a service is identified, features in more dimensions are required, and therefore accuracy of data stream identification is improved.

IV. Performing Traffic Identification Based on a Single-Stream Feature and a Transaction Feature:

Another embodiment of a traffic detection method provided in this application includes: obtaining a plurality of packets collected by a traffic collection device in a first time period; determining a target feature set based on the plurality of packets, where the target feature set includes a single-stream feature corresponding to a first data stream in the first time period, and a transaction feature corresponding to a transaction in the first data stream in the first time period; and determining, based on the target feature set and a correspondence between the target feature set and a service type, a service type corresponding to the first data stream in the first time period.

In this embodiment, the plurality of packets are collected in the first data stream in the first time period.

The determining a target feature set based on the plurality of packets specifically includes: determining, based on the plurality of packets included in the first data stream collected in the first time period, the single-stream feature corresponding to the first data stream in the first time period; and determining, based on a plurality of packets included in the transaction in the first data stream collected in the first time period, the transaction feature corresponding to the transaction in the first data stream collected in the first time period.

Specifically, for a method for determining, based on the plurality of packets included in the first data stream collected in the first time period, the single-stream feature corresponding to the first data stream in the first time period, refer to the foregoing embodiments. For a specific method for determining, based on the plurality of packets included in the transaction in the first data stream collected in the first time period, the feature of the transaction in the first data stream in the first time period, refer to the foregoing embodiments.

In this embodiment, when searching a feature library for a similar feature set, a traffic detection device not only needs to compare single-stream features, but also needs to compare transaction features. In comparison with identification of a service type of a data stream based on only a single-stream feature, more features can be used in this embodiment to indicate the data stream more completely and accurately. When a service is identified, features in more dimensions are required, and therefore accuracy of data stream identification is improved.

V. Performing Traffic Identification Based on a Transaction Feature:

Referring to FIG. 9, another example embodiment of a traffic detection method provided in an embodiment of this application includes the following steps.

Step 901: Obtain a plurality of packets collected by a traffic collection device in a first time period.

In this embodiment, the plurality of packets include packets of at least one transaction in a first data stream in the first time period.

Step 902: Determine a target feature set based on the plurality of packets, where the target feature set includes a feature of a transaction in the first data stream collected in the first time period.

The feature of the transaction includes a statistical parameter about sizes of the plurality of packets included in the transaction. Optionally, the feature of the transaction further includes at least one of a statistical parameter about reception time intervals corresponding to the plurality of packets included in the transaction or a statistical parameter about transmission rates of the plurality of packets included in the transaction, and the reception time interval corresponding to the plurality of packets is a reception time interval between any two consecutively received packets in the plurality of packets. The statistical parameter includes at least one of an average value, a maximum value, a minimum value, a standard deviation, a quantile, kurtosis, skewness, or a spectrum parameter.

Step 903: Determine, based on the target feature set and a correspondence between the target feature set and a service type, a service type corresponding to the first data stream in the first time period.

In this embodiment, a feature library includes a plurality of feature sets, and each feature set includes but is not limited to a transaction feature set.

A traffic detection device may obtain the feature library locally or from a network storage server. When the target feature set is a feature set in the feature library, the service type corresponding to the first data stream in the first time period is determined based on the target feature set and the correspondence between the target feature set and the service type.

When the feature library does not include the target feature set, the feature library is searched for a first feature set having a highest similarity with the target feature set among feature sets in the feature library, and then a service type corresponding to the first feature set is used as a service type corresponding to the transaction in the first data stream in the first time period. The feature set having the highest similarity with the target feature set specifically means that a similarity between a transaction feature set included in the target feature set and a transaction feature set included in the first feature set is the highest. Alternatively, after the feature library is searched for a feature set having a similarity with the target feature set higher than a preset threshold, a service type corresponding to the found feature set is used as a service type corresponding to the transaction in the first data stream in the first time period.

In this embodiment, the traffic detection device may determine, based on the feature of the transaction in the first data stream, the service type corresponding to the first data stream. Therefore, a new method for identifying a data stream is provided and has good feasibility.

In an optional embodiment, after step 901, the method further includes: determining a feature of a first transaction based on a plurality of packets included in the first transaction; and determining, based on the feature of the first transaction, and a correspondence between the feature of the first transaction and a service type, a service type corresponding to the first transaction. The first transaction is any one of the at least one transaction in the first data stream.

For example, a preset transaction feature set includes four feature sets, and features in the feature sets include an average value of sizes of packets. Average values of sizes of packets in the four feature sets are 200 bytes, 500 bytes, 800 bytes, and 1000 bytes respectively. A service type corresponding to the 200 bytes is a web browsing service, and a service type corresponding to the 1000 bytes is an online video service.

If the first time period is [0 s, 10 s], 10 transactions are obtained from the first data stream in [0 s, 5 s], where a fifth transaction includes 10 packets. For the fifth transaction, an average value of sizes of the 10 packets is calculated and is 200 bytes. Because the 200 bytes belong to the preset transaction feature set, it is determined, based on a correspondence between the 200 bytes and the service type, that the service type corresponding to the fifth transaction is the web browsing service.

If 20 transactions are obtained from the first data stream in [0 s, 10 s], a tenth transaction includes 15 packets. For the tenth transaction, an average value of sizes of the 15 packets is calculated and is 1100 bytes. Because the preset transaction feature set does not include a feature value of 1100 bytes, the traffic detection device searches the preset transaction feature set for a feature value having a highest similarity with the 1100 bytes, for example, 1000 bytes. A service type (that is, the online video service) corresponding to the 1000 bytes is used as a service type corresponding to the tenth transaction, that is, the online video service. In this way, the traffic detection device can determine a service type corresponding to each transaction, and accuracy of traffic detection can be further improved.

In another optional embodiment, the method further includes: training a plurality of new samples and a plurality of historical samples by using a machine learning algorithm, to update a correspondence between a feature set and a service type in the feature library, where the plurality of new samples include a sample corresponding to the transaction in the first data stream in the first time period, and the sample corresponding to the transaction in the first data stream includes the feature and the service type of the transaction in the first data stream.

In this embodiment, after step 903, the transaction feature and the service type that correspond to the transaction in the first data stream may be used as a new sample. By using the foregoing method, another new sample may be further obtained in a subsequent time period, or a transaction feature and a service type that correspond to a transaction in a second data stream are used as a new sample. Then a plurality of new samples and a plurality of historical samples are trained by using the machine learning algorithm, to update the correspondence between a feature set and a service type.

Because the generated new samples and the historical samples are trained together, the correspondence between a feature set and a service type can be updated and corrected, and the updated correspondence between a feature set and a service type is closer to the current correspondence between a data stream and a service type and can also be more diversified. By using the updated correspondence between a feature set and a service type during identification, on one hand, more data streams can be identified, and on the other hand, accuracy of traffic detection can also be improved. In addition, because the correspondence between a feature set and a service type is updated in real time, a service type corresponding to a new data stream in an embodiment can be identified. This can resolve a problem that a new data stream cannot be detected based on an offline sample training method.

To avoid adding a feature set having a low similarity and a service type corresponding to the feature set to a sample set used for training, this application provides a plurality of methods for selecting new samples, to remove low-confidence samples from the new samples and ensure that all samples that are trained are high-confidence samples. The following provides detailed descriptions.

In an optional embodiment, at least one first new sample is included in the plurality of new samples, the first new sample corresponds to a feature set in the feature library, the first new sample includes a group of high-confidence features, a similarity between the group of high-confidence features and the feature set in the feature library satisfies a preset condition, and a service type included in the first new sample is the same as a service type corresponding to the feature set corresponding to the first new sample.

In this embodiment, types of features included in the target feature set and the first feature set are the same.

After the target feature set corresponding to the first data stream is determined, the feature library is searched for the first feature set having the highest similarity with the target feature set among feature sets in the feature library. Whether the similarity between the target feature set and the first feature set is not lower than a preset similarity threshold is determined; and if the similarity is not lower than the preset similarity threshold, the target feature set is determined as a high-confidence feature set, and the target feature set and the service type corresponding to the first feature set are used as a first new sample; or if the similarity is lower than the preset similarity threshold, the target feature set is determined as a low-confidence feature set, and the feature set and the service type corresponding to the feature set are not used as a sample. In this way, a high-confidence feature set and a service type corresponding to the high-confidence feature set are used as a new sample, and using a sample including a low-confidence feature set as a training sample is avoided.

In another optional embodiment, at least one other new sample is included in the plurality of new samples. The method further includes: obtaining a server identity that corresponds to a transaction in a data stream collected by the traffic collection device in a time period, where the server identity includes an Internet Protocol (IP) address of a server and a name of the server, determining, based on a correspondence between the server identity and a service type, a service type corresponding to the transaction in the data stream; and storing a second new sample corresponding to the transaction in the data stream, where the second new sample includes the service type and a transaction feature of the transaction.

In this embodiment, the traffic detection device may parse a packet header to obtain the server identity, and the server identity includes but is not limited to the IP address of the server and the server name. The server name is SNI information that is obtained by parsing an encryption handshake message, or http.host information (such as a domain name) that is obtained by parsing an HTTP header.

A transaction obtained from the first data stream in a time period includes a plurality of packets, and after a transaction feature and a service type that correspond to the plurality of packets are determined, the transaction feature and the service type are used as a second new sample for storage. In an embodiment, some servers provide only one type of service. Therefore, the type of the service provided by the server can be identified rapidly by using the server identity.

In addition to the foregoing example, the traffic detection device may further obtain a plurality of packets included in the first data stream collected by the traffic collection device in the first time period, determine a single-stream feature of the first data stream based on the plurality of packets included in the first data stream, and then determine the service type of the first data stream in the first time period based on the single-stream feature of the first data stream and a correspondence between the single-stream feature and a service type.

Based on the foregoing traffic detection method, a target feature set and a service type that correspond to each data stream can be determined. In an embodiment, a correspondence between a data stream and a service type is complex.

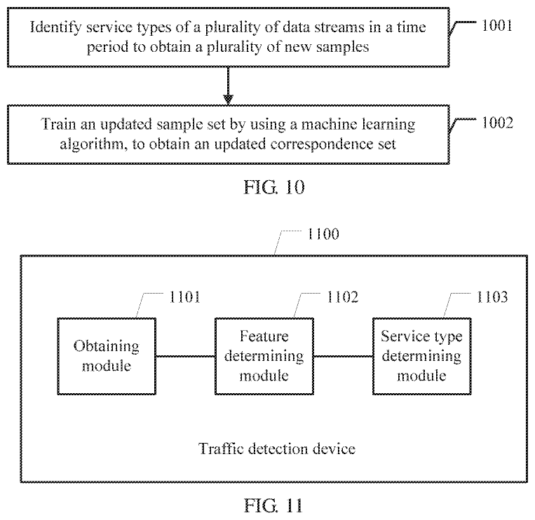

Referring to FIG. 10, an example sample training method according to an embodiment of this application includes the following steps.

Step 1001: Identify service types of a plurality of data streams in a time period to obtain a plurality of new samples.

In this embodiment, a multi-stream feature and a service type may be determined based on a plurality of packets included in a plurality of data streams in a time period. A single-stream feature of a data stream may be determined based on a plurality of packets included in the data stream in a time period. A feature of a transaction in a data stream may be determined based on a plurality of packets included in the transaction in the data stream in a time period. Therefore, an obtained target feature set includes at least one of a multi-stream feature, a single-stream feature, or a transaction feature. After a service type corresponding to the target feature set is determined, the target feature set and the service type are used as a new sample.

Step 1002: Train an updated sample set by using a machine learning algorithm, to obtain an updated correspondence set.

The correspondence set includes a plurality of mapping relationships, the mapping relationships are mapping relationships between feature sets and service types, the updated sample set includes a plurality of new samples and a plurality of historical samples, each sample in the updated sample set includes one service type and a plurality of features, the plurality of features include at least one of a multi-stream feature, a single-stream feature, or a transaction feature, and each of the multi-stream feature, the single-stream feature, and the transaction feature includes at least one statistical parameter.

In this embodiment, because the generated new samples and the historical samples are trained together, the correspondence between a feature set and a service type can be updated and corrected, and the stored correspondence between the feature set and the service type is closer to the current correspondence between a data stream and a service type and can also be more diversified. By using the updated correspondence between a feature set and a service type during identification, on one hand, more data streams can be identified, and on the other hand, accuracy of traffic detection can also be improved.

In an optional embodiment, at least one first new sample is included in the plurality of new samples, the first new sample corresponds to a feature set in a feature library, the first new sample includes a group of high-confidence features, a similarity between the group of high-confidence features and the feature set in the feature library satisfies a preset condition, and a service type included in the first new sample is the same as a service type corresponding to the feature set corresponding to the first new sample.

In this embodiment, after a target feature set corresponding to a first data stream is determined, the feature library is searched for a first feature set having a highest similarity with the target feature set among feature sets in the feature library. Whether the similarity between the target feature set and the first feature set is not lower than a preset similarity threshold is determined; and if the similarity is not lower than the preset similarity threshold, the target feature set is determined as a high-confidence feature set, and the target feature set and a service type that corresponds to the first feature set are used as a first new sample; or if the similarity is lower than the preset similarity threshold, the target feature set is determined as a low-confidence feature set, and the target feature set and a service type corresponding to the target feature set are not used as a sample. In this way, a high-confidence feature set and a service type corresponding to the high-confidence feature set are used as a new sample, and using a sample including a low-confidence feature set as a training sample is avoided.

In another optional embodiment, at least one other new sample is included in the plurality of new samples.

The method further includes: obtaining a server identity that corresponds to a data stream collected by a traffic collection device in a time period, where the server identity includes an IP address of a server and a name of the server, determining a service type of the data stream based on a correspondence between the server identity and a service type; and storing a second new sample corresponding to the data stream in the time period, where the second new sample includes the service type of the data stream and a multi-stream feature of the data stream.

In this embodiment, the traffic detection device may parse a packet header to obtain the server identity, and the server identity includes but is not limited to the IP address of the server and the server name. The server name is SNI information that is obtained by parsing an encryption handshake message, or http.host information (such as a domain name) that is obtained by parsing an HTTP header.

A plurality of packets in the first data stream and a second data stream are obtained in a time period, and after a target feature set and a service type corresponding to the plurality of packets are determined, the target feature set and the service type are used as a second new sample for storage. In an embodiment, some servers provide only one type of service. Therefore, the type of the service provided by the server can be identified rapidly by using the server identity.

Because a service type of a data stream transmitted in a network is identified, differences between service requirements of a user on different services can be further analyzed. This is very important for operations such as network optimization and network fault diagnosis in the network and monitoring of user experience quality in the network. Therefore, by using any method described in this application, a service type of a data stream in a time period can be identified more accurately. The following briefly describes a procedure for monitoring service quality of a network by using an identified service type, where the service quality of the network is indicated by a parameter KQI.

In the prior art, traffic types are not distinguished during network quality evaluation, and it is difficult to accurately reflect differences between service requirements of a user on different services. In example embodiments of this application, user experience quality monitoring, network optimization, and network fault diagnosis can be performed based on a correspondence between a traffic type and a service type and a correspondence between the service type and a KQI parameter, thereby improving user experience.

An example service analysis method provided in an embodiment of this application includes: determining, based on a service type corresponding to a first data stream in a time period, a KQI parameter corresponding to the first data stream in the time period; determining whether the KQI parameter is not less than a preset KQI; and if the KQI parameter is less than the preset KQI, performing root cause analysis based on the service type, and performing a subsequent procedure based on an analysis result.

In this embodiment, a service analysis module may obtain a preset correspondence between a service type and a KQI parameter locally or from a network storage server. For example, a KQI parameter of a web browsing service includes but is not limited to a web page loading delay. A KQI parameter of an online video service includes but is not limited to video freezing duration. A KQI parameter of a VoIP service includes but is not limited to a call duration. A KQI parameter of a file transfer service includes but is not limited to a download rate. After the KQI parameter is determined, KQI parameter values of a plurality of packets are calculated.

The preset KQI is used to measure whether user experience quality is acceptable. After a KQI parameter value of the data stream is determined, whether the KQI parameter value is higher than the preset KQI is determined. If the KQI parameter value is higher than or equal to the preset KQI, it indicates that the KQI satisfies a user experience quality requirement. If the KQI parameter value is less than the preset KQI, it indicates that the KQI of the data stream does not satisfy a user experience quality requirement. If the KQI does not satisfy user experience quality requirement, it indicates that user experience is poor, and the user experience needs to be improved. To satisfy users, preset KQIs of different services are set to different values. For example, on a normal user experience level, a data transmission rate of web browsing is 500 kbps, a data transmission rate of file transfer is 4000 kbps, and a data transmission rate of an online video service is 900 kbps. To be specific. KQI of the rate of file transfer >KQI of the rate of the online video service >KQI of the rate of web browsing.

The user experience quality may be monitored based on an analysis result. If a complaint of a user is received, an analysis result may be matched with the complaint of the user, and the analysis result may be fed back to the user. For the file transfer service, a link round trip delay, a packet loss rate, and a sending window are analyzed. For the online video service, a video bitrate, a packet loss rate in an initial video buffering phase, and a sending window are analyzed. If the analysis result is a network delay, a network optimization solution is generated. If the analysis result is a network fault, an alarm notification is delivered and a network fault diagnosis solution is generated.

In this embodiment, user experience quality monitoring, network optimization, and network fault diagnosis may be performed based on a correspondence between a traffic type and a service type and a correspondence between a service type and a KQI, thereby improving user experience.

Example embodiments of this application provide a traffic detection device 1100. The traffic detection device 1100 can implement the traffic detection method in the embodiment shown in FIG. 4 or the optional embodiment. Referring to FIG. 11, a non-limiting, example traffic detection device 1100 includes:

an obtaining module 1101, configured to obtain a plurality of packets collected by a traffic collection device in a first time period, where the plurality of packets include packets in a first data stream and at least one other data stream associated with the first data stream, and the first data stream and the at least one other data stream are data streams of a same user;

a feature determining module 1102, configured to determine a target feature set based on the plurality of packets, where the target feature set includes a multi-stream feature corresponding to the plurality of packets, and the multi-stream feature includes a statistical parameter about sizes of the plurality of packets; and

a service type determining module 1103, configured to determine, based on the target feature set and a correspondence between the target feature set and a service type, a service type corresponding to the first data stream in the first time period.

The traffic detection device 1100 in this embodiment can implement the traffic detection method in a plurality of the foregoing method embodiments, for example, the embodiment shown in FIG. 4 or the optional embodiment. For specific implementations, technical effects, and descriptions about terms, refer to corresponding descriptions of the foregoing embodiments or the optional embodiment. For example, the obtaining module 1101 may be configured to perform a plurality of other implementations of step 401 and steps of obtaining packets in various implementations of performing traffic identification by using any one or more of a single-stream feature, a multi-stream feature, and a transaction feature; the feature determining module 1102 may be configured to perform a plurality of other implementations of step 402 and steps of determining a target feature set in various implementations of performing traffic identification by using any one or more of a single-stream feature, a multi-stream feature, or a transaction feature; and the service type determining module 1103 may be configured to perform a plurality of other implementations of step 403 and steps of determining a service type in various implementations of performing traffic identification by using any one or more of a single-stream feature, a multi-stream feature, or a transaction feature.

In an optional embodiment, the multi-stream feature further includes at least one of a statistical parameter about reception time intervals corresponding to the plurality of packets or a statistical parameter about transmission rates of the plurality of packets, and the reception time interval corresponding to the plurality of packets is a reception time interval between any two consecutively received packets in the plurality of packets.

In another optional embodiment, the first time period is related to a statistical parameter of a plurality of packets collected by the traffic collection device in a second time period.

In another optional embodiment,

the obtaining module 1101 is configured to: obtain a plurality of packets collected by the traffic collection device in a second time period, where the plurality of packets collected in the second time period include packets in the first data stream and the at least one other data stream; and if a time difference between a time of receiving a last packet in the first data stream by the traffic collection device in the second time period and an end time of the second time period is less than a preset threshold, obtain a plurality of packets collected by the traffic collection device in a third time period, where a sum of the second time period and the third time period is the first time period.

In another optional embodiment, the obtaining module 1101 is configured to: obtain a plurality of packets collected by the traffic collection device in a second time period, where the plurality of packets collected in the second time period include packets in the first data stream and the at least one other data stream; and if a total amount of data received by the traffic collection device in the second time period is greater than a preset data amount, obtain a plurality of packets collected by the traffic collection device in a third time period, where a sum of the second time period and the third time period is the first time period.

In another optional embodiment, the service type determining module 1103 is configured to: find a first feature set in a feature library based on the target feature set, where the first feature set is a feature set having a highest similarity with the target feature set; and determine, based on a correspondence between the first feature set and a service type, the service type corresponding to the first data stream in the first time period, where the service type corresponding to the first data stream in the first time period is the same as the service type corresponding to the first feature set.

In another optional embodiment, the target feature set further includes a single-stream feature corresponding to the packets in the first data stream that are collected in the first time period, and the single-stream feature includes a statistical parameter about sizes of the collected packets in the first data stream.

In another optional embodiment, the single-stream feature further includes at least one of a statistical parameter about reception time intervals of the collected packets in the first data stream or a statistical parameter about transmission rates thereof, where the reception time interval is a reception time interval between any two consecutively received packets in the collected packets in the first data stream.

In another optional embodiment, the target feature set further includes a feature of a transaction in the first data stream collected in the first time period, the transaction includes a plurality of packets, the plurality of packets included in the transaction are a request and at least one response corresponding to the request, and the feature of the transaction includes a statistical parameter about sizes of the plurality of packets included in the transaction.

In another optional embodiment, the feature of the transaction further includes a statistical parameter about reception time intervals corresponding to the plurality of packets included in the transaction and a statistical parameter about transmission rates of the plurality of packets included in the transaction.

In the foregoing embodiments, the statistical parameter includes at least one of an average value, a maximum value, a minimum value, a standard deviation, a quantile, kurtosis, skewness, or a spectrum parameter.

In another optional embodiment, the traffic detection device 1100 further includes:

a training module 1201, configured to train a plurality of new samples and a plurality of historical samples by using a machine learning algorithm, to update a correspondence between a feature set and a service type in the feature library, where the plurality of new samples include a sample corresponding to the first data stream in the first time period, and the sample corresponding to the first data stream includes a multi-stream feature and the service type of the first data stream.

In another optional embodiment, at least one first new sample is included in the plurality of new samples, the first new sample corresponds to a feature set in the feature library, the first new sample includes a group of high-confidence features, a similarity between the group of high-confidence features and the feature set in the feature library satisfies a preset condition, and a service type included in the first new sample is the same as a service type corresponding to the feature set corresponding to the first new sample.

Referring to FIG. 13, in another optional embodiment, at least one other new sample is included in the plurality of new samples;

the service type determining module 1103 is further configured to: obtain a server identity that corresponds to a data stream collected by the traffic collection device in a time period, where the server identity includes an Internet Protocol (IP) address of a server and a name of the server, and determine a service type of the data stream based on a correspondence between the server identity and a service type; and

the traffic detection device 1100 further includes:

a storage module 1301, configured to store a second new sample corresponding to the data stream, where the second new sample includes the service type and a multi-stream feature of the data stream in the time period.

It may be understood that, functions of the obtaining module 1101, the feature determining module 1102, the service type determining module 1103, the training module 1201, and the storage module 1301 may be all implemented by the data processing module of the traffic detection device shown in FIG. 2. Alternatively, the obtaining module 1101, the feature determining module 1102, the service type determining module 1103, the training module 1201, and the storage module 1301 are implemented by independent modules having the foregoing functions respectively, where the independent modules may be integrated in one device, or may be distributed on different devices.

Based on the traffic detection device 1100 shown in FIG. 11, the traffic detection method in the embodiment shown in FIG. 9 or the optional embodiment can be implemented. Another embodiment of the traffic detection device 1100 includes:

an obtaining module 1101, configured to obtain a plurality of packets collected by a traffic collection device in a first time period, where the plurality of packets include packets of at least one transaction in a first data stream in the first time period;

a feature determining module 1102, configured to determine a target feature set based on the plurality of packets, where the target feature set includes a feature of the transaction in the first data stream collected in the first time period, a plurality of packets included in the transaction are a request and at least one response corresponding to the request, and the feature of the transaction includes a statistical parameter about sizes of the plurality of packets included in the transaction; and

a service type determining module 1103, configured to determine, based on the target feature set and a correspondence between the target feature set and a service type, a service type corresponding to the first data stream in the first time period.

The traffic detection device 1100 in this embodiment can implement the traffic detection method in the embodiment shown in FIG. 9 or the optional embodiment. For specific implementations, technical effects, and descriptions about terms, refer to corresponding descriptions of the embodiment shown in FIG. 9 or the optional embodiment. For example, the obtaining module 1101 may be configured to perform a plurality of other implementations of step 901 and steps of obtaining packets in various implementations of performing traffic identification by using any one or more of a single-stream feature, a multi-stream feature, or a transaction feature; the feature determining module 1102 may be configured to perform a plurality of other implementations of step 902 and steps of determining a target feature set in various implementations of performing traffic identification by using any one or more of a single-stream feature, a multi-stream feature, or a transaction feature; and the service type determining module 1103 may be configured to perform a plurality of other implementations of step 903 and steps of determining a service type in various implementations of performing traffic identification by using a transaction feature.

In an optional embodiment, the feature of the transaction further includes at least one of a statistical parameter about reception time intervals corresponding to the plurality of packets included in the transaction or a statistical parameter about transmission rates of the plurality of packets included in the transaction, and the reception time interval corresponding to the plurality of packets is a reception time interval between any two consecutively received packets in the plurality of packets.

In another optional embodiment,

the feature determining module 1102 is further configured to determine a feature of a first transaction based on a plurality of packets included in the first transaction, where the first transaction is any one of the at least one transaction; and

the service type determining module 1103 is further configured to determine, based on the feature of the first transaction and a correspondence between the feature of the first transaction and a service type, a service type corresponding to the first transaction.

In the foregoing embodiments, the statistical parameter includes at least one of an average value, a maximum value, a minimum value, a standard deviation, a quantile, kurtosis, skewness, or a spectrum parameter.

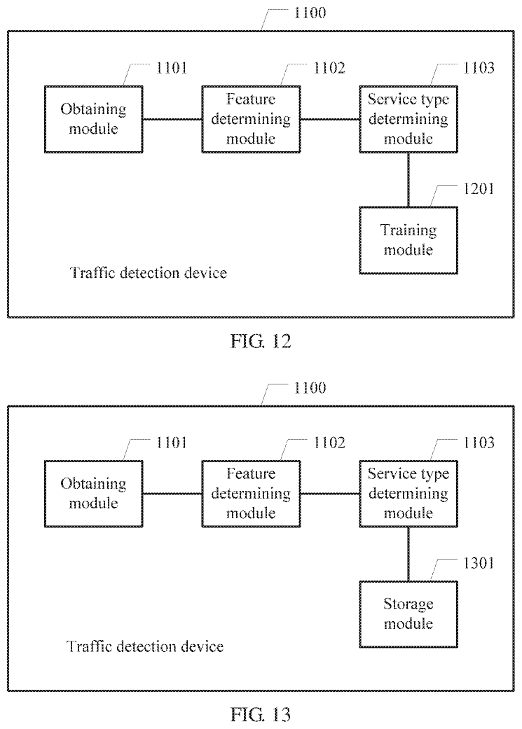

In another optional embodiment, as shown in FIG. 12, the traffic detection device 1100 further includes a training module 1201, configured to train a plurality of new samples and a plurality of historical samples by using a machine learning algorithm, to update a correspondence between a feature set and a service type in a feature library, where the plurality of new samples include a sample corresponding to a transaction in the first data stream in the first time period, and the sample corresponding to the transaction in the first data stream includes a feature and a service type of the transaction in the first data stream.

In another optional embodiment, at least one first new sample is included in the plurality of new samples, the first new sample corresponds to a feature set in the feature library, the first new sample includes a group of high-confidence features, a similarity between the group of high-confidence features and the feature set in the feature library satisfies a preset condition, and a service type included in the first new sample is the same as a service type corresponding to the feature set in the feature library corresponding to the first new sample.

Based on the traffic detection device shown in FIG. 13, in another optional embodiment, at least one other new sample is included in the plurality of new samples;

the service type determining module 1103 is further configured to: obtain a server identity that corresponds to the transaction in the first data stream collected by the traffic collection device in the first time period, where the server identity includes an Internet Protocol (IP) address of a server and a name of the server; and determine the service type of the transaction in the first data stream based on a correspondence between the server identity and a service type; and

the traffic detection device 1100 further includes:

a storage module 1301, configured to store a second new sample corresponding to the transaction in the first data stream in the first time period, where the second new sample includes the service type of the transaction in the first data stream and the feature of the transaction in the first data stream, and the feature of the transaction includes at least one statistical parameter.

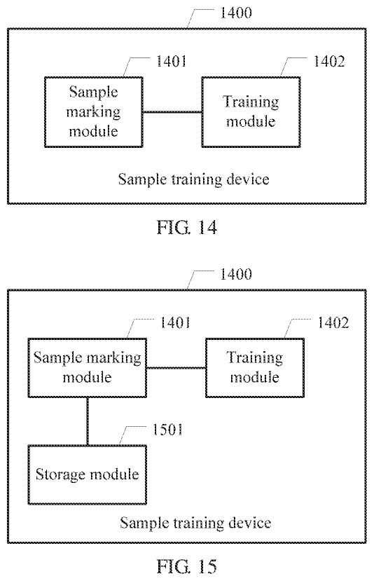

Referring to FIG. 14, this application provides a non-limiting, example sample training device 1400. The sample training device 1400 can implement the sample training method in the embodiment shown in FIG. 10. An embodiment of the sample training device 1400 includes:

a sample marking module 1401, configured to identify service types of a plurality of data streams in a time period to obtain a plurality of new samples; and

a training module 1402, configured to train an updated sample set by using a machine learning algorithm, to obtain an updated correspondence set, where the updated correspondence set includes a plurality of mapping relationships, and the mapping relationships are mapping relationships between feature sets and service types, where the updated sample set includes a plurality of new samples and a plurality of historical samples, each sample in the updated sample set includes one service type and a plurality of features, the plurality of features include at least one of a multi-stream feature, a single-stream feature, or a transaction feature, and each of the multi-stream feature, the single-stream feature, and the transaction feature includes at least one statistical parameter.

The sample training device 1400 in this embodiment can implement the sample training method in the embodiment shown in FIG. 10 or the optional embodiment. For specific implementations, technical effects, and descriptions about terms, refer to corresponding descriptions of the embodiment shown in FIG. 10 or the optional embodiment. For example, the sample marking module 1401 may be configured to perform a plurality of other implementations of step 1001 and steps of obtaining packets in various implementations of performing traffic identification by using any one or more of a single-stream feature, a multi-stream feature, or a transaction feature; and the training module 1402 may be configured to perform a plurality of other implementations of step 1002.

In an optional embodiment, at least one first new sample is included in the plurality of new samples, the first new sample corresponds to a feature set in a feature library, the first new sample includes a group of high-confidence features, a similarity between the group of high-confidence features and the feature set in the feature library satisfies a preset condition, and a service type included in the first new sample is the same as a service type corresponding to the feature set corresponding to the first new sample.

Referring to FIG. 15, in another optional embodiment, at least one other new sample is included in the plurality of new samples;

the sample marking module 1401 is further configured to: obtain a server identity that corresponds to a data stream collected by a traffic collection device in a time period, where the server identity includes an Internet Protocol (IP) address of a server and a name of the server; and determine a service type of the data stream based on a correspondence between the server identity and a service type; and

the sample training device 1400 further includes:

a storage module 1501, configured to store a second new sample corresponding to the data stream in the time period, where the second new sample includes the service type of the data stream and a multi-stream feature of the data stream.

The sample training device 1400 in this embodiment can implement the sample training method in the embodiment shown in FIG. 10 or the optional embodiments. For specific implementations, technical effects, and descriptions about terms, refer to corresponding descriptions of the embodiment shown in FIG. 10 or the optional embodiments.

It may be understood that, functions of the sample marking module 1401, the training module 1402, and the storage module 1501 may be implemented by the data processing module of the traffic detection device shown in FIG. 2. Alternatively, the sample marking module 1401, the training module 1402, and the storage module 1501 are implemented by independent modules having the foregoing functions respectively, where the independent modules may be integrated in a device, or may be distributed on different devices.

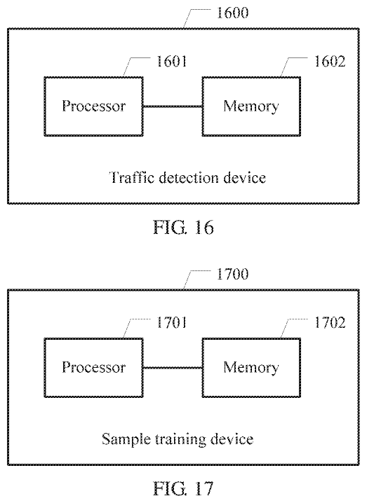

Based on the foregoing methods provided in embodiments of this application, this application provides a non-limiting, example traffic detection device 1600, configured to implement functions of the traffic detection device in the foregoing methods. As shown in FIG. 16, the traffic detection device 1600 includes a processor 1601 and a memory 1602, where the processor 1601 is connected to the memory 1602. It should be noted that, the traffic detection device is usually a network-side device, for example, may be a server or a gateway. When the traffic detection device is a server, the server may further include input and output devices and a communications interface. The input device may be a device configured to input information, such as a keyboard or a mouse. The output device may be a display. The communications interface is configured to communicate with another device in a network.

The processor 1601 may be a general purpose processor, including a central processing unit (CPU), a network processor (NP), or the like; or may be a digital signal processor (DSP), an application-specific integrated circuit (ASIC), a field-programmable gate array (FPGA) or another programmable logic device, or the like.

The memory 1602 is configured to store a program and a packet. Specifically, the program may include program code, and the program code includes computer operation instructions. The memory 1602 may include a random access memory (RAM), or may further include a non-volatile memory (NVM), for example, at least one disk storage. The processor 1601 executes the program code stored in the memory 1602 to implement the method in the embodiment shown in FIG. 4 or the optional embodiment, or the embodiment shown in FIG. 9 or the optional embodiment.

In an implementation, the processor 1601 may implement functions of the obtaining module 1101, the feature determining module 1102, the service type determining module 1103, and the training module 1201 in the embodiment shown in FIG. 11. The memory 1602 may implement the functions of the storage module 1301 under control of the processor 1601.

Based on the foregoing methods provided in this application, this application provides a non-limiting, example sample training device 1700, configured to implement functions of the sample training device in the foregoing methods. As shown in FIG. 17, the traffic sample training device 1700 includes a processor 1701 and a memory 1702, where the processor 1701 is connected to the memory 1702. It should be noted that, the sample training device is usually a network-side device, for example, a server or a gateway. When the sample training device is a server, the server may further include an input device and an output device and a communications interface. The input device may be a device configured to input information, such as a keyboard or a mouse. The output device may be a display. The communications interface is configured to communicate with another device in a network.

The processor 1701 may be a general purpose processor, including a CPU, an NP, or the like; or may be a DSP, an ASIC, an FPGA or another programmable logic device, or the like.

The memory 1702 is configured to store a program and a packet. Specifically, the program may include program code, and the program code includes computer operation instructions. The memory 1702 may include a RAM, or may further include an NVM, for example, at least one disk storage. The processor 1701 executes the program code stored in the memory 1702 to implement the method in the embodiment shown in FIG. 10 or the optional embodiment.

In another implementation, the processor 1701 may implement functions of the sample marking module 1401 and the training module 1402 in the embodiment shown in FIG. 14. The memory 1702 may implement the function of the storage module 1501 under control of the processor 1701.

This application provides a computer-readable storage medium, including instructions, where when the instructions are run on a computer, the computer is enabled to perform the method provided in any one of the foregoing embodiments.

All or some of the foregoing embodiments may be implemented by software, hardware, firmware, or any combination thereof. When software is used to implement the embodiments, the embodiments may be implemented completely or partially in a form of a computer program product.

The computer program product includes one or more computer instructions. When the computer program instructions are loaded and executed on the computer, the procedure or functions according to the embodiments of the present application are all or partially generated. The computer may be a general-purpose computer, a dedicated computer, a computer network, or other programmable apparatuses. The computer instructions may be stored in a computer-readable storage medium or may be transmitted from one computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a Solid State Disk (SSD)), or the like.

The foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of this application.

What is claimed is:

1. A traffic detection method, comprising:
obtaining a plurality of packets collected by a traffic collection device in a first time period, wherein the plurality of packets comprise packets in a first data stream and at least one other data stream collected in the first time period, and the first data stream and the at least one other data stream are data streams of a same user,
determining a target feature set based on the plurality of packets, wherein the target feature set comprises a multi-stream feature corresponding to the plurality of packets, and the multi-stream feature comprises a statistical parameter about sizes of the plurality of packets; and
determining, based on the target feature set and a correspondence between the target feature set and a service type, a service type corresponding to the first data stream collected in the first time period.

2. The method according to claim 1, wherein the multi-stream feature further comprises at least one of a statistical parameter about reception time intervals corresponding to the plurality of packets or a statistical parameter about transmission rates of the plurality of packets.

3. The method according to claim 1, wherein the first time period is related to a statistical parameter of packets collected by the traffic collection device in a second time period, the plurality of packets collected in the first time period comprising the packets collected in the second time period.

4. The method according to claim 1, wherein the obtaining a plurality of packets collected by a traffic collection device in a first time period comprises:
obtaining a plurality of packets collected by the traffic collection device in a second time period, wherein the plurality of packets collected in the second time period comprise packets in the first data stream and the at least one other data stream;
determining whether a time difference between a time of receiving a last packet in the first data stream by the traffic collection device in the second time period and an end time of the second time period is less than a preset threshold, and
in response to the determination that the time difference between the time of receiving the last packet in the first data stream by the traffic collection device in the second time period and the end time of the second time period is less than the preset threshold, obtaining a plurality of packets collected by the traffic collection device in a third time period, wherein a sum of the second time period and the third time period is the first time period.

5. The method according to claim 1, wherein the obtaining a plurality of packets collected by a traffic collection device in a first time period comprises:
obtaining a plurality of packets collected by the traffic collection device in a second time period, wherein the plurality of packets collected in the second time period comprise packets in the first data stream and the at least one other data stream;
determining whether a total amount of data received by the traffic collection device in the second time period is greater than a preset data amount; and
in response to the determination that the total amount of data received by the traffic collection device in the second time period is greater than the preset data amount, obtaining a plurality of packets collected by the traffic collection device in a third time period, wherein a sum of the second time period and the third time period is the first time period.

6. The method according to claim 1, wherein the determining, based on the target feature set and a correspondence between the target feature set and a service type, a service type corresponding to the first data stream collected in the first time period comprises:
determining a first feature set in a feature library based on the target feature set, the first feature set having a highest similarity with the target feature set among feature sets in the feature library; and
determining, based on a correspondence between the first feature set and a service type, the service type corresponding to the first data stream collected in the first time period, wherein the service type corresponding to the first data stream collected in the first time period is the same as the service type corresponding to the first feature set.

7. The method according to claim 1, wherein the target feature set further comprises a single-stream feature corresponding to the packets in the first data stream that are collected in the first time period, and the single-stream feature comprises a statistical parameter about sizes of the collected packets in the first data stream.

8. The method according to claim 7, wherein the single-stream feature further comprises at least one of a statistical parameter about reception time intervals of the collected packets in the first data stream or a statistical parameter about transmission rates of the collected packets in the first data stream.

9. The method according to claim 1, wherein the target feature set further comprises a feature of a transaction in the first data stream collected in the first time period, the transaction comprises a plurality of packets, the plurality of packets comprised in the transaction include a request and at least one response corresponding to the request, and the feature of the transaction comprises a statistical parameter about sizes of the plurality of packets comprised in the transaction.

10. The method according to claim 9, wherein the feature of the transaction further comprises a statistical parameter about reception time intervals corresponding to the plurality of packets comprised in the transaction and a statistical parameter about transmission rates of the plurality of packets comprised in the transaction.

11. A traffic detection method, comprising:
obtaining a plurality of packets collected by a traffic collection device in a first time period, wherein the plurality of packets comprise packets of a transaction in a first data stream collected in the first time period;
determining a target feature set based on the plurality of collected packets, wherein the target feature set comprises a feature of the transaction in the first data stream collected in the first time period, the packets of the transaction include a request and at least one response corresponding to the request, and the feature of the transaction comprises a statistical parameter about sizes of the packets of the transaction; and
determining, based on the target feature set and a correspondence between the target feature set and a service type, a service type corresponding to the first data stream collected in the first time period.

12. The method according to claim 11, wherein the feature of the transaction further comprises at least one of a statistical parameter about reception time intervals corresponding to the packets of the transaction or a statistical parameter about transmission rates of the packets of the transaction, and the reception time interval corresponding to the packets of the transaction is a reception time interval between any two consecutively received packets in the packets.

13. The method according to claim 11, further comprising:
determining a feature of a first transaction based on a plurality of packets comprised in the first transaction, wherein the first transaction is in the first data stream; and
determining, based on the feature of the first transaction and a correspondence between the feature of the first transaction and a service type, a service type corresponding to the first transaction.

14. The method according to claim 11, wherein the statistical parameter comprises at least one of an average value, a maximum value, a minimum value, a standard deviation, a quantile, kurtosis, skewness, or a spectrum parameter.

15. The method according to claim 11, further comprising:
training a plurality of new samples and a plurality of historical samples by using a machine learning algorithm, to update a correspondence between a feature set and a service type in a feature library, wherein the plurality of new samples comprise a sample corresponding to the transaction in the first data stream collected in the first time period, and the sample corresponding to the transaction in the first data stream comprises the feature of the transaction in the first data stream and the service type corresponding to the first data stream.

16. The method according to claim 15, wherein the plurality of new samples comprises a first new sample corresponding to a feature set in the feature library, the first new sample comprises a group of high-confidence features and a service type, a similarity between the group of high-confidence features and the feature set in the feature library satisfies a preset condition, and the service type in the first new sample is the same as a service type corresponding to the feature set in the feature library corresponding to the first new sample.

17. The method according to claim 15, wherein the plurality of new samples comprises at least one other new sample, and the method further comprises:
obtaining a server identity corresponding to the transaction in the first data stream collected by the traffic collection device in the first time period, wherein the server identity comprises an Internet Protocol (IP) address of a server and a name of the server,
determining the service type corresponding to the transaction in the first data stream based on a correspondence between the server identity and a service type; and storing a second new sample corresponding to the transaction in the first data stream collected in the first time period, wherein the second new sample comprises the service type of the transaction in the first data stream and the feature of the transaction in the first data stream, and the feature of the transaction comprises at least one statistical parameter.

18. A sample training method, comprising:
identifying service types of a plurality of data streams in a time period to obtain a plurality of new samples; and
training an updated sample set by using a machine learning algorithm, to obtain an updated correspondence set, wherein the updated correspondence set comprises a plurality of mapping relationships between feature sets and service types, wherein
the updated sample set comprises a plurality of new samples and a plurality of historical samples, each sample in the updated sample set comprises one service type and a plurality of features, the plurality of features comprise at least one of a multi-stream feature, a single-stream feature, or a transaction feature, and each of the multi-stream feature, the single-stream feature, and the transaction feature comprises at least one statistical parameter.

19. The method according to claim 18, wherein the plurality of new samples comprises a first new sample corresponding to a feature set in a feature library, the first new sample comprises a group of high-confidence features and a service type, a similarity between the group of high-confidence features and the feature set in the feature library satisfies a preset condition, and the service type in the first new sample is the same as a service type corresponding to the feature set in the feature library corresponding to the first new sample.

20. The method according to claim 18, wherein the plurality of new samples comprises at least one other new sample, and the method further comprises:
obtaining a server identity corresponding to a data stream collected by a traffic collection device in a time period, the server identity comprising an Internet Protocol (IP) address of a server and a name of the server;
determining a service type of the collected data stream based on a correspondence between the server identity and a service type; and storing a second new sample corresponding to the data stream collected in the time period, wherein the second new sample comprises the service type of the collected data stream and a multi-stream feature of the collected data stream.
